(19) United States
(12) Patent Application Publication
(10) Pub. No.: US 2022/0368625 A1
(43) Pub. Date: Nov. 17, 2022

(54) MULTIPATH ROUTING IN COMMUNICATION NETWORKS

(71) Applicant: CURATED NETWORKS, Santa Cruz, CA (US)

(72) Inventors: Bradley R. Smith, Santa Cruz, CA (US); Jose J. Garcia-Luna-Aceves, San Mateo, CA (US)

(21) Appl. No.: 17/760,814

(22) PCT Filed: Oct. 9, 2020
(86) PCT No.: PCT/US2020/055117

§ 371 Date: Mar. 16, 2022

Related U.S. Application Data
(60) Provisional application No. 62/913,019, filed on Oct. 9, 2019.
(60) Provisional application No. 62/913,027, filed on Oct. 9, 2019.
(60) Provisional application No. 62/913,038, filed on Oct. 9, 2019.

(51) Int. Cl. H04L 45/24; H04L 45/50

(52) U.S. Cl. CPC H04L 45/24; H04L 45/507

(57) ABSTRACT

Systems, methods, and computer-readable media for multipath routing in data communication networks are provided.

### CROSS-REFERENCE TO RELATED APPLICATION(S)

This application claims the benefit of prior filed U.S. Provisional Patent Application No. 62/913,019, filed Oct. 9, 2019, of prior filed U.S. Provisional Patent Application No. 62/913,027, filed Oct. 9, 2019, and of prior filed U.S. Provisional Patent Application No. 62/913,038, filed Oct. 9, 2019, each of which is hereby incorporated by reference herein in its entirety.

### COPYRIGHT NOTICE

At least a portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### TECHNICAL FIELD

This disclosure relates to communication networks and, more particularly, to multipath routing in data communication networks.

### BACKGROUND OF THE DISCLOSURE

Internet routing may be based on use of a best path to a given destination. Some best-path models may limit communication applications to the use of a single-path in an Internet environment. Furthermore, a common use of destination-based forwarding in the Internet is a particularly aggressive form of single-path communication. With destination-based forwarding, the path used to carry traffic through an intermediate node to a destination is often an extension of the path from the intermediate node to the destination. This strong tendency for traffic to be concentrated on a subset of available paths may result in inefficient use of network resources, such as with traffic experiencing congestion while network resources may be idle.

### SUMMARY OF THE DISCLOSURE

This document describes systems, methods, and computer-readable media for providing multipath routing in data communication networks.

For example, a method for communicating data in a data network including a plurality of router nodes is provided, where the method may include computing, for each router node of the plurality of router nodes, a best set of routes subject to a partial ordering, assigning, at each router node of the plurality of router nodes, a local label that is unique to the particular router node for each computed route of the computed best set of routes for the particular router node, and defining, at a first router node of the plurality of router nodes, a next hop label for a first computed route of the computed best set of routes for the first router node based on the local label assigned for the first computed route at a second router node of the plurality of router nodes that is the next hop router node from the first router node for the first computed route.

As yet another example, a method for communicating data in a data network including a plurality of router nodes is provided, where the method may include defining Boolean variables reflecting states relevant to policies for resource utilization of the data network, defining Boolean expressions with the define Boolean variables for providing constraints, computing routes and forwarding traffic within the data network based on the defined Boolean expressions, determining when a state change occurs that results in a change in a value of any defined Boolean variable, and, in response to the determining, at least one of recomputing the routes or updating forwarding rules associated with the routes.

As yet another example, a method for communicating data in a data network including a plurality of router nodes is provided, where the method may include identifying Boolean variables relevant to policies for resource utilization of the data network, classifying each identified Boolean variable as at least one of a routing variable or a forwarding variable, using at least one classified routing variable to carry out a routing computation for the data network, and using at least one classified forwarding variable to carry out a path selection computation for the data network.

As yet another example, a method for communicating data in a data network including a plurality of router nodes is provided, where the method may include computing, for each router node of the plurality of router nodes, a best set of routes subject to a partial ordering, assigning, at each router node of the plurality of router nodes, a local label that is unique to the particular router node for each computed route of the computed best set of routes for the particular router node, and defining, at each router node of the plurality of router nodes, a next hop label for each computed route of the computed best set of routes for the particular router node based on the local label assigned for the particular computed route at the router node that is the next hop router node from the particular router node for the particular computed route

This Summary is provided to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a schematic diagram illustrating a system including portion of a communications network including multiple router devices and a central network controller device, according to some embodiments of the disclosure;

FIG. 1A is a more detailed schematic view of a system device of the system of FIG. 1;

FIG. 2 is a schematic diagram illustrating data structures used by a routing process of the disclosure;

FIG. 3 is a schematic diagram illustrating path selection of flows in a network router device according to some embodiments of the disclosure;

FIG. 4 illustrates a flowchart of an exemplary process for packet routing according to some embodiments of the disclosure;

FIG. 5 shows a part of a network where the number of hops between routing devices varies and where each device does or does not satisfy a particular Boolean test according to some embodiments of the disclosure;

FIGS. 6A and 6B show a pair of truth tables corresponding to FIG. 5;

FIG. 7 shows routing table entries computed for a Boolean Constrained Multipath Routing algorithm according to some embodiments of the disclosure with respect to the network of FIG. 5;

FIG. 8 shows, for different routes, the truth assignments to variables in Boolean constraints of FIG. 7;

FIGS. 9 and 10 show routing table entries of illustrative data structures with respect to the network of FIG. 5;

FIG. 11 shows destination independent multipath forwarding table entries of an illustrative data structure with respect to the network of FIG. 5;

FIGS. 12 and 13 illustrate flowcharts of exemplary processes for providing multipath routing;

FIG. 14 shows a part of a network with different links associated with different Boolean constraints and with different nodes associated with different communication table data structures;

FIG. 15 illustrates a flowchart of an exemplary process for providing autonomic network routing;

FIG. 16 shows a part of another network with different links associated with different Boolean constraints;

FIG. 17 shows a part of yet another network with different links associated with different Boolean constraints; and

FIG. 18 illustrates a flowchart of an exemplary process for processing Boolean constraints for use in multipath routing.

### DETAILED DESCRIPTION OF THE DISCLOSURE

Systems, methods, and computer-readable media for providing multipath routing in data communication networks are provided.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. The term “and/or” as used herein may refer to and encompass any and all possible combinations of one or more of the associated listed items. The terms “includes,” “including,” “comprises,” and/or “comprising,” when used in this specification, may specify the presence of stated features, integers, steps, operations, elements, and/or components, but do not preclude the presence or addition of one or more other features, integers, steps, operations, elements, components, and/or groups thereof.

The term “if” may, optionally, be construed to mean “when” or “upon” or “in response to determining” or “in response to detecting,” depending on the context. Similarly, the phrase “if it is determined” or “if [a stated condition or event] is detected” may, optionally, be construed to mean “upon determining” or “in response to determining” or “upon detecting [the stated condition or event]” or “in response to detecting [the stated condition or event],” depending on the context.

As used herein, the terms “computer,” “personal computer,” “device,” “computing device,” “router device,” and “controller device” may refer to any programmable computer system that is known or that will be developed in the future. In certain embodiments, a computer may be coupled to a network, such as described herein. A computer system may be configured with processor-executable software instructions to perform the processes described herein. Such computing devices may be mobile devices, such as a mobile telephone, data assistant, tablet computer, or other such mobile device. Alternatively, such computing devices may not be mobile (e.g., in at least certain use cases), such as in the case of server computers, desktop computing systems, or systems integrated with non-mobile components.

As used herein, the terms “component,” “module,” and “system” may be intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The Internet may be based on a single-path communications model. This model may impose significant constraints on the ability of the Internet to satisfy any quality-of-service (“QoS”) requirements of network applications, and may result in significant inefficiencies in the use of network resources that may be manifested as congestion. This has often resulted in over-provisioning Internet-based systems to meet the basic needs of modern communications. With the adoption of the Internet as the converged communication infrastructure for the 21st century, this may not be an acceptable long-term solution.

Two basic approaches to packet switching may be virtual circuits and datagrams. Both schemes may segment messages into limited-size packets, add control information to each packet to accomplish its switching, and rely on statistical multiplexing of the shared communication links. Virtual circuits may emulate circuit-switching, such as used in the early telephone network. The virtual-circuit model may be connection-oriented, in that communication may occur in three phases (e.g., path setup, data transfer, and path teardown), routing may be done once per flow by the ingress node during path setup, and paths may be implemented using label-swap forwarding such that all traffic for a given flow may follow the same path through the network. It is to be understood that the term “path” and the term “route” may be used interchangeably herein (e.g., when referring to a computed path or route between a start node or router and an end node or router).

In contrast, packet switching based on datagrams may be a more drastic departure from the circuit-switching model. Datagram switching may be connectionless in that there may be no phases in the communication process, packets may be transmitted when the source host is ready to transmit, routing may be computed at every router in the network on an event-driven basis, and the forwarding decision may be made on a hop-by-hop basis as packets flow through the network with the result that different packets in a given flow may follow different paths through the network.

The datagram approach to packet switching has a number of strengths. It is robust in the sense that it may co-locate the routing process with the state it computes, manifesting a design principle called fate-sharing. This may ensure that the failure of any single component of an internet does not invalidate one or more states located elsewhere in the internet, effectively localizing the effects of any failures. The datagram model may be efficient and responsive for a couple of reasons. First, by implementing distributed control of forwarding state it may require only simplex communication of topology change events. Second, by assuming a distributed, hop-by-hop routing model, the datagram model may enable the use of more efficient and responsive routing algorithms that can operate with partial information regarding the topology of the network.

Virtual-circuit switching may be based on a centralized routing model in that routes may be computed on-demand, and forwarding may be source-specified through the use of path setup techniques. Hence, virtual circuits may be less robust than datagrams due to the ingress router controlling remote forwarding state in routers along the paths it has set up. The virtual-circuit model may be less efficient and responsive for a couple of reasons. First, by implementing centralized control of forwarding state, it may require duplex communication of topology change events, outbound notification of a topology event, and inbound notification of forwarding state changes. Second, by assuming a centralized routing computation, the virtual-circuit model may require the use of full-topology routing algorithms to ensure every router can compute optimal paths to any destination in an internet.

The architecture of today's Internet may be based on the catenet model of internetworking. In the catenet model, networks may be built by the concatenation of disparate networks through the use of routers. The primary goals of the catenet model, and therefore the Internet architecture, may be to support packet-switched communication between computers over internets composed of networks based on diverse network technologies, and to encourage the development and integration of new networking technologies into these internets.

To achieve these goals, a simple but powerful variant of the datagram communication model may be adopted. Specifically, the Internet routing architecture may be based on a best effort communication model in which the “best” path may be pre-computed by each router to all destinations (e.g., triggered by topology changes), and packets may be forwarded on a best effort basis (and may be dropped or delivered out of order in the event of congestion or routing changes). Packet forwarding may be implemented on a hop-by-hop basis using a destination-address based packet forwarding state computed by the routing process.

This best-effort, distributed, hop-by-hop, datagram routing model has proven surprisingly powerful. Indeed, much of the success of the Internet architecture can be attributed to its routing model. However, largely as a product of its own success, limitations of this model are being encountered as it is applied to more demanding applications.

A significant limitation may be the model only supports a single path to each destination. Specifically, Internet forwarding state may be composed of a single entry for each destination in an internet giving the next-hop router on the path to the destination. As a result, only one path may be supported to any given destination, and that path may be computed to optimize a single metric.

Unfortunately, the single-path limitation of the Internet may not be adequate for many of the demanding applications to which the Internet is currently being applied, such as the need for routing flows according to desired policies.

In addition, single-path routing may result in significant inefficiencies in the use of network resources. With single-path routing, multiple flows can be routed over one or more congested links while other regions of the network are lightly loaded.

In view of the above, it is desirable to improve support for implementing routing policies as well as the use of multiple paths for congestion control while being compatible with the Internet architecture in terms of implementing a datagram communication model (e.g., pre-computation of routes and hop-by-hop forwarding).

Two enhancements to the Internet architecture may attempt to solve the problem of resource management in the context of performance requirements: the Intserv and Diffserv architectures.

A goal of the integrated services (Intserv) architecture may be to define an integrated Internet service model that supports best-effort, real-time, and controlled link sharing requirements. Intserv may make the assumption that network resources may be explicitly controlled, and may define an architecture where applications may reserve the network resources required to implement their functionality, and an infrastructure of admission control, traffic classification, and traffic scheduling mechanisms that implement the reservations. In the Intserv architecture, resource reservations may be sent along paths computed by the existing routing infrastructure. As a result, requests may be denied when resources do not exist along the current route when in fact paths exist that could satisfy the request. Intserv may be based on a virtual-circuit communications model and, as such, may have all the limitations of that model relating to robustness, efficiency, and responsiveness discussed above.

In contrast, the differentiated services (Diffserv) architecture may provide resource management without the use of explicit reservations. In Diffserv, a small set of per-hop forwarding behaviors (“PHBs”) may be defined within a Diffserv domain that may provide resource management services appropriate to a class of application resource requirements. Traffic classifiers may be deployed at the edge of a Diffserv domain that classify traffic for one of these PHBs. Inside a Diffserv domain, routing may be performed using traditional hop-by-hop, address-based forwarding mechanisms.

Diffserv may retain the best-effort, distributed, hop-by-hop, datagram routing model of the Internet, and therefore may retain the robustness, efficiency, and responsiveness of the Internet. However, similar to the Intserv model, communications resources to a given flow in a Diffserv environment may be limited to those available along the paths computed by the existing routing infrastructure.

In addition, significant research has been done into multipath solutions for QoS and congestion, with a search for comprehensive solution that may be compatible with the Internet's datagram, hop-by-hop model of communication.

Paganini and Mallada (“A unified approach to congestion control and node-based multipath routing,” IEEE/ACM Transactions on Networking, 17(5):1413-1426, October 2009) may present a solution for implementing congestion control in the network layer. The solution may compute multiple paths per destination in the routing computation and distribute traffic among these paths in response to a local measure of congestion based on queueing delay. Results may be presented from simulations run with a RIP-based implementation of the algorithm. The solution may pre-compute paths, and use hop-by-hop forwarding. However it may only address congestion control.

In summary, a comprehensive, multipath solution that both supports policies for flows and addresses congestion that is consistent with the Internet architecture's use of pre-computed routes and hop-by-hop forwarding is desirable.

A solution to the problems of congestion and providing policy-control of the use of network resources for network applications and administrators may be through the routing of traffic over multiple paths between a given source and destination. Constraints can be defined using a Boolean Algebra where Boolean variables may be used to represent policy-relevant properties of network traffic and network state, and Boolean expressions composed of these variables may express the constraints that may be required of flows using the network. A set of paths may simultaneously provide a full range of policies available in the network. This set of paths may be used to load balance traffic (e.g., to avoid congestion) and/or to select paths for flow requests that may meet the policy constraints of the specific flow. These constraints can run from a full range of policies available in a network (e.g., where the application requirements may be not known ahead of time or may be changing), to a set of specific constraint targets that may be selected to meet the needs of a set of applications.

Policy requirements of a flow may be specified in a declarative manner, allowing the network users and administrators to state what performance and policies routes used for a given application should provide without requiring the specification of an exact procedure to be used in selecting appropriate paths. This may make it possible to assign flows to paths that may both satisfy the desired policies and minimize congestion. In comparison, other solutions may require a detailed specification of how to compute paths that meet the requirements for a given communication application.

A possible solution of this disclosure may provide a number of potential commercial advantages in the network routing market. As one example, routes may be selected that satisfy policy constraints (e.g., as specified by the user and/or network owner), which may support a number of specific uses, such as service differentiation for network services (e.g., Bronze, Silver, Gold level network access) that may allow for increased revenue from existing network infrastructure, support for micro-segmentation with a network security model where fine-grained security policies may be enforced down to the workload level that may allow military-style Multi-Level Security (“MLS”) or, more generally, restriction of traffic to subsets of a network, to be enforced in an Internet environment.

Micro-segmentation may be implemented in virtualized environments. More broadly, lack of micro-segmentation capabilities in the Internet may result in the need to physically implement redundant networks to meet these policy constraints. As another example, the computation of multiple paths to each destination may result in the availability of a number of paths that satisfy a given network flow. This may provide the opportunity to select the path from these options that minimizes congestion.

Certain techniques may use Boolean Constrained Multipath Routing (“BCMR”) together with BCMR-compatible forwarding techniques. A BCMR algorithm may compute the shortest set of routes between each source node and destination node that may satisfy the full range of policy constraints possible in the network. This set may be used to route flows over paths that satisfy the desired policy constraints on the use of network resources for a given flow.

Policy constraints may be specified using Boolean expressions that may be composed of a subset of Boolean variables that may represent policy-relevant properties of network traffic, network resources, and network state. For each flow request, there may be a set of Boolean expressions (e.g., specifying the policy constraints for the flow) that may express the desired policies for routing of traffic for the given flow in the network.

A BCMR algorithm may compute, for each truth assignment to the flow's policy constraints, the shortest route from the set of routes where this truth assignment may be satisfying for the flow's policy constraints. This set of routes may represent a best satisfying set of routes between the source and destination that may provide the shortest paths for the full set of truth assignments that may be satisfying for the flow constraints. A traffic classification function may be then defined for assigning new flows to paths that may meet the Boolean constraints relevant for the new flow and may have capacity for the new flow, thereby reducing congestion.

Thus, a solution may be provided to the problems of congestion and providing policy control for network applications through the routing of traffic over multiple paths between a given source and destination. This may enable use of a set of paths that satisfies the full range of policies needed of a network for the applications to be deployed over the network. This set of paths may be used to load balance traffic (e.g., to avoid congestion) and/or to select paths for flow requests that may meet the policy requirements of a specific flow. This set of policies can range from the full range of policies supported by a network (e.g., where the application requirements are not known ahead of time or are changing), to a set of specific targets selected to meet the needs of a set of applications (e.g., for the network to be used for military multi-level-security, a set of Boolean constraints may be defined that provide hierarchical security with the common example of unclassified, secret, and top secret security levels).

A packet routing method may be implemented in a data network by network routing equipment. Preferably, the network may be a wired data network and the packets may be routed over wired connections between network routers. A solution method may include computing, for each source node in the data network and each destination node in the data network, a set of multiple routes providing the shortest paths for a full range of policies from the source node to the destination node. The multiple routes may be preferably precomputed and stored. The full range of policies may be defined by a set of best satisfying routes, which may be defined as follows. Given a flow request, for each route from the source node to the destination node, there may be a set of Boolean constraints that define the policy requirements for the given flow to use that path, and truth assignments (e.g., the flow request truth assignment) to some subset of the Boolean variables contained in this set of Boolean constraints. Each of the shortest satisfying routes may be defined as the shortest route for a truth assignment that satisfies the Boolean constraints in the context of the flow request truth assignment.

A solution method may additionally or alternatively include selecting, for a packet originating from a source node and addressed to a destination node, a route from the computed set of multiple routes, where the selecting may include (i) determining the Boolean constraints for the packet based on traffic classification rules, and (ii) selecting the route that minimizes network congestion and satisfies the Boolean constraint requirements for the packet. A solution method may additionally or alternatively include forwarding the packet in accordance with the selected route.

The selecting may include determining Boolean constraints for the packet based on traffic classification rules that may be specified in terms of contents of the packet, in terms of a user associated with the packet, in terms of a port the packet arrives on, and/or in terms of one or more other environmental factors.

A solution method may additionally or alternatively be implemented in a data network by performing all operations at a single network router device. A solution method may additionally or alternatively be implemented in a data network by performing computing and selecting operations at a central network controller device, and performing a forwarding operation at a network router device. Such an implementation may correspond to a “software-defined networking” approach, a popular example being “OpenFlow.” A solution method may additionally or alternatively be implemented in a data network by performing a computing operation at a central network controller device, and performing selecting and forwarding operations at a network router device.

In some embodiments, selecting a route may include, if a label-swap tag is not present in the packet, computing the label-swap tag from traffic classification rules that may be specified in terms of contents of the packet, in terms of a user associated with the packet, in terms of a port the packet arrives on, and/or in terms of one or more other environmental factors. If a label-swap tag is already present in the packet, the forwarding may include forwarding the packet based on the label-swap tag in the packet.

In some embodiments, selecting a route may include, if a source route is not present in the packet, computing the source route from traffic classification rules that may be specified in terms of contents of the packet, in terms of a user associated with the packet, in terms of a port the packet arrives on, and/or in terms of one or more other environmental factors. If a source route is already present in the packet, the forwarding may include forwarding the packet based on the source route in the packet.

In some embodiments, selecting the route may include, if a segment list is not present in the packet, computing the segment list from traffic classification rules that may be specified in terms of contents of the packet, in terms of a user associated with the packet, in terms of a port the packet arrives on, and/or in terms of one or more other environmental factors. If a segment list is already present in the packet, the forwarding may include forwarding the packet based on the segment list in the packet.

In some embodiments, selecting a route may include performing network load balancing among a computed set of multiple routes.

In addition, in some embodiments, selecting a set of routes may select the dominant set of routes for each satisfying truth assignment, or may select a set of routes that meets specific performance needs of a predetermined set of applications that are to be deployed over the network. This targeted or customized routing model can be valuable in some circumstances (e.g., to reduce the overhead costs of this kind of routing). In general, a method may compute routes with the full range of performance requirements for a satisfying truth assignment when the application mix is not known ahead of time or is continually changing, and the method may compute routes using targeted routing for each satisfying truth assignment when the application mix is fixed or predetermined and efficiency is important.

Therefore, use of the Internet may involve a wide range of applications with diverse requirements in terms of policy constraints. The diverse requirements of these applications may not be well served by existing Internet routing architecture. An architecture that may make use of a set of paths between each source and destination that support the full range of policies available in a network may be beneficial.

The problems of congestion and providing policy-control of the use of network resources for network applications and administrators may be addressed through the routing of traffic over multiple paths between a given source and destination. An example of this policy-control relating to the use of a network may be in a military context where paths may be rated as to the level of sensitivity of content they can carry (e.g., TOP-SECRET, SECRET, UNCLASSIFIED). One path that traverses links that provide a high level of security (e.g., fiber optic links, which may be difficult to tap, in secured facilities, wireless links using strong encryption protocols where the end-points may be in secured facilities, etc.) may be rated to carry TOP-SECRET traffic, while another path composed only of relatively unsecured links (e.g., a path over the public Internet) may be rated to only carry UNCLASSIFIED traffic. In the abstract, these paths may be not comparable. However, in the context of a specific use, one may generally be clearly preferred over the other (e.g., sensitive military operational traffic may require the TOP-SECRET path while general web browsing may make use of the UNCLASSIFIED path).

These constraints can be defined using a Boolean Algebra where Boolean variables may be used to represent policy-relevant properties of network traffic and network state, and Boolean expressions composed of these variables may express the policy constraints required of flows using the network.

Therefore, certain techniques may use a Boolean algebra to define and compute the set of paths in a network that may satisfy constraints defined using the Boolean algebra, as may be described in U.S. Patent Application Publication No. 2020/0236034, which is hereby incorporated by reference herein in its entirety. Additionally, U.S. Pat. No. 9,197,544, which is hereby incorporated by reference herein in its entirety, discusses the use of a path algebra in the context of dominant path routing instead of a Boolean algebra for Boolean constrained routing.

A Boolean algebra can be used in a “General-Policy-Based Dijkstra” algorithm to compute the set of paths that may simultaneously provide the full range of policies (e.g., in terms of the Boolean constraints) available in the network.

The computation of routes subject to Boolean constraints expressing policies, and the use of these paths subject to congestion reduction, may be provided by solution methods herein. This disclosure also provides a forwarding technique based on the routing.

A flow may be defined as a sequence or set or stream of packets that may satisfy or be subject to the same set of constraints (e.g., performance constraints and/or policy constraints and/or service chaining constraints, etc.) (e.g., Boolean constraints only or both Boolean constraints and performance constraints)) and may therefore be subject to the same set of policies. The term flow in the present context might not be related to Internet Protocol version 6 (“IPv6”), and, actually, may be independent of any specific protocol.

One path value (x) may be said to dominate another (y) where the set of truth assignments where y is true is a subset of the truth assignments where x is true (e.g., in their truth tables), whereby the Boolean expression x satisfies more truth assignments than y. For a network example, if there is a shorter path A with path value Boolean expression y and a longer path B with Boolean expression x, route B may ought to be included in the routing tables because, even though it is longer, it satisfies some potential truth assignments that the shorter route A does not satisfy.

In dominant set multipath routing (“DSMR”), dominance in DSMR may be defined differently, such as by U.S. Pat. No. 9,197,544, as follows: “[t]he full range of performance is defined by a set of dominant routes, where each route from the source node to the destination node in the data network has multiple distinct performance metrics defining coordinates of a corresponding point in a multi-dimensional space. The multiple distinct performance metrics defining coordinates of the multi-dimensional space may include, for example, metrics such as a bandwidth metric, a latency metric, a jitter metric, and a reliability metric. Each of the dominant routes is defined as a route that has a corresponding point in the multi-dimensional space that is maximal with respect to a partial order defined on points in the multi-dimensional space corresponding to routes from the source node to the destination node.” Multiple distinct route performance metrics may be represented as points in a multi-dimensional space, such that the routes can be organized using a partial ordering of the points. The term “partial order” may be defined in accordance with its standard mathematical definition (e.g., a partial order on a set R may be a relation that is reflexive, anti-symmetric, and transitive). A partial order may be distinguished from a familiar notion of a linear order (or total order). For example, the relation “≤” (less than or equal) may define a linear order on the set of real numbers. This linear order may have the property that, given two numbers a and b, it is always the case that a≤b or b≤a. With a partial order, however, this property (e.g., as may be called comparability) may not be in general satisfied for any two elements. Moreover, whereas a finite set may have just one unique linear order, it can have multiple distinct partial orderings. Routes in a network may correspond to points in a multi-dimensional space, and a partial order may be defined on this set of points. Weights of a set of paths to a destination may be viewed as a partially ordered set, and a dominant set of weights for such a partial order may be computed as a foundation of a forwarding table.

For BCMR, dominance may be defined very differently, where, for example, a Boolean expression can be described using a truth table with one column for each Boolean variable in the expression, and a final column for the Boolean expression, and where each row may contain a truth assignment of the values of either True or False to each variable (e.g., for n variables, there will be 2ⁿ rows), and the expression column may show the value of the expression given the truth assignments to the variables in that row.

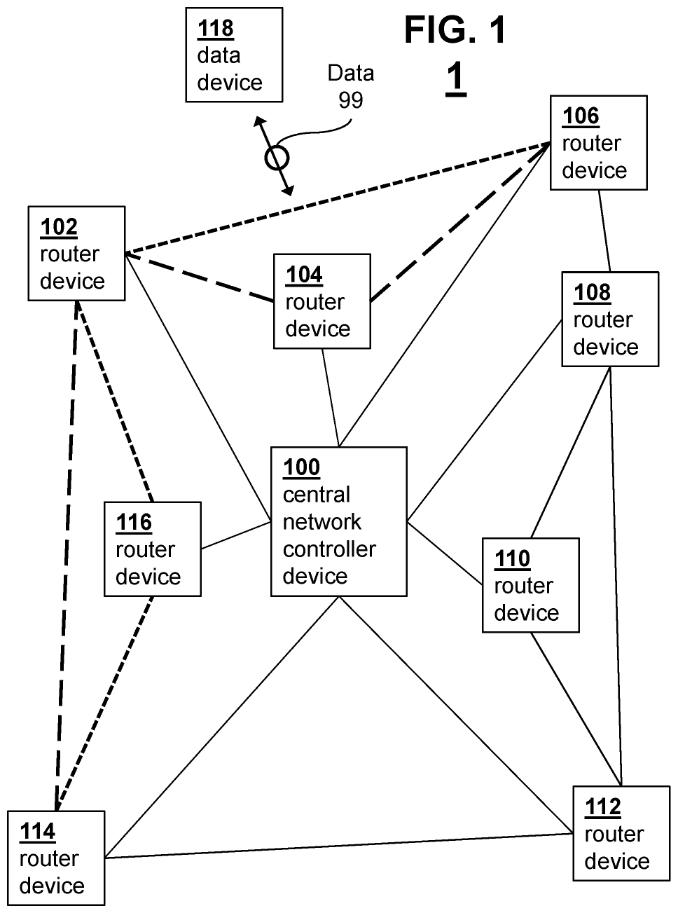

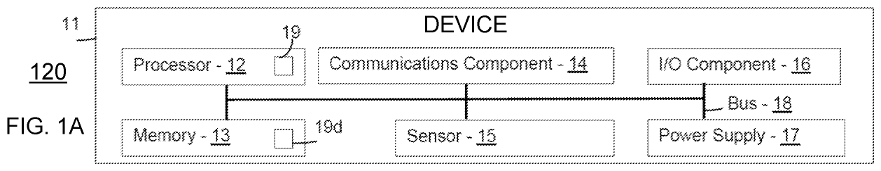

FIG. 1 is a schematic diagram illustrating a portion of any suitable system 1 that may include any suitable network of suitable number of any suitable type(s) of router devices, such as router devices 102, 104, 106, 108, 110, 112, 114, and 116. As shown, in some embodiments, the network may also include any suitable type of central network controller device 100. The dashed lines may indicate two alternate routes between device 106 and device 114. One route, indicated by a short dashed line, passes through intermediate devices 102 and 116. Another route, indicated by a long dashed line, passes through intermediate devices 104 and 102. These two routes might, for example, represent the multiple routes providing a full range of policies from a source node (e.g., device 106) and a destination node (e.g., device 114). Router devices 102-116 may be conventional routers with standard forwarding technologies integrated into these routers and their software, modified to implement one, some, or all of the techniques described herein. In some embodiments, the computing of the multiple paths, the selecting of a route, and/or the forwarding operations described herein may all performed by each of router devices 102-116. In these embodiments, central controller 100 may not be necessary and may be eliminated. In other embodiments, compatible with “Open Flow” approaches to routing, central controller 100 may compute the multiple routes. This precomputed routing information may then be transmitted to each router device. For example, controller 100 may compute the multiple routes from router 106 to router 114, then remotely update the forwarding states of routers as appropriate. Each router with a packet to forward may then independently select a route from the multiple routes and forward the packet over the selected route. This may be particularly useful in the case of a small or medium internet service provider (“ISP”), or organizations such as universities or larger corporations. In yet another embodiment, central controller 100 may not only compute the multiple routes, but may also select routes. For example, a router 106 may query central controller 100 as needed to determine a route to forward a packet over. Central controller 100 may select a route from the multiple routes and inform the router of the selection as a response to the query. In this embodiment, it may not be necessary for central network controller 100 to transmit computed multiple route forwarding information to the router devices. Allowing the central controller to select routes may allow more intelligent congestion control in the network, but may increase latency. As shown in FIG. 1, system 1 may also include one or more data devices, such as data device 118, which may be a source of any suitable data 99 that may be communicatively coupled to one, some, or each of devices 100-116 in any suitable manner for sharing any suitable data with the device(s) of the network for any suitable purpose.

As shown in FIG. 1A, a system device 120 (e.g., one, some, or each of devices 100-118 of system 1 of FIG. 1) may include a processor component 12, a memory component 13, a communications component 14, a sensor 15, an input/output (“I/O”) component 16, a power supply component 17, a housing 11, and/or a bus 18 that may provide one or more wired or wireless communication links or paths for transferring data and/or power to, from, or between various other components of device 120. In some embodiments, one or more components of device 120 may be combined or omitted. Moreover, device 120 may include other components not combined or included in FIG. 1A and/or several instances of the components shown in FIG. 1A. For the sake of simplicity, only one of each of the components of device 120 is shown in FIG. 1A. I/O component 16 may include at least one input component (e.g., button, mouse, keyboard, etc.) to receive information from a user and/or at least one output component (e.g., audio speaker, video display, haptic component, etc.) to provide information to a user, such as a touch screen that may receive input information through a user's touch of a display screen and that may also provide visual information to a user via that same display screen. Memory 13 may include one or more storage mediums or media, including for example, a hard-drive, flash memory, permanent memory such as read-only memory (“ROM”), semi-permanent memory such as random access memory (“RAM”), any other suitable type of storage component, or any combination thereof (e.g., for storing data (e.g., forwarding data, table(s), algorithms, etc. (e.g., data 19d))). Communications component 14 may be provided to allow device 120 to communicate with one or more other devices 120 (e.g., any device communication to/from/between device(s) 100-118 of system 1) using any suitable communications protocol. Communications component 14 can be operative to create or connect to a communications network or link of a network. Communications component 14 can provide wireless communications using any suitable short-range or long-range communications protocol, such as Wi-Fi (e.g., an 802.11 protocol), Bluetooth, radio frequency systems (e.g., 1200 MHz, 2.4 GHz, and 5.6 GHz communication systems), near field communication (“NFC”), infrared, protocols used by wireless and cellular telephones and personal e-mail devices, or any other protocol supporting wireless communications. Communications component 14 can also be operative to connect to a wired communications link or directly to another data source wirelessly or via one or more wired connections. Communications component 14 may be a network interface that may include the mechanical, electrical, and/or signaling circuitry for communicating data over physical links that may be coupled to other devices of a network. Such network interface(s) may be configured to transmit and/or receive any suitable data using a variety of different communication protocols, including, but not limited to, TCP/IP, UDP, ATM, synchronous optical networks (“SONET”), any suitable wireless protocols, Frame Relay, Ethernet, Fiber Distributed Data Interface (“FDDI”), and/or the like. In some embodiments, one, some, or each of such network interfaces may be configured to implement one or more virtual network interfaces, such as for Virtual Private Network (“VPN”) access.

Sensor 15 may be any suitable sensor that may be configured to sense any suitable data for device 120 (e.g., location-based data via a GPS sensor system, motion data, environmental data, biometric data, etc.). Sensor 15 may be a sensor assembly that may include any suitable sensor or any suitable combination of sensors operative to detect movements of device 120 and/or of any user thereof and/or any other characteristics of device 120 and/or of its environment (e.g., physical activity or other characteristics of a user of device 120, light content of the device environment, gas pollution content of the device environment, noise pollution content of the device environment, altitude of the device, etc.). Sensor 15 may include any suitable sensor(s), including, but not limited to, one or more of a GPS sensor, wireless communication sensor, accelerometer, directional sensor (e.g., compass), gyroscope, motion sensor, pedometer, passive infrared sensor, ultrasonic sensor, microwave sensor, a tomographic motion detector, a camera, a biometric sensor, a light sensor, a timer, or the like. Sensor 15 may include any suitable sensor components or subassemblies for detecting any suitable movement of device 120 and/or of a user thereof. For example, sensor 15 may include one or more three-axis acceleration motion sensors (e.g., an accelerometer) that may be operative to detect linear acceleration in three directions (i.e., the x- or left/right direction, the y- or up/down direction, and the z- or forward/backward direction). As another example, sensor 15 may include one or more single-axis or two-axis acceleration motion sensors that may be operative to detect linear acceleration only along each of the x- or left/right direction and the y- or up/down direction, or along any other pair of directions. In some embodiments, sensor 15 may include an electrostatic capacitance (e.g., capacitance-coupling) accelerometer that may be based on silicon micro-machined micro electro-mechanical systems (“MEMS”) technology, including a heat-based MEMS type accelerometer, a piezoelectric type accelerometer, a piezo-resistance type accelerometer, and/or any other suitable accelerometer (e.g., which may provide a pedometer or other suitable function). Sensor 15 may be operative to directly or indirectly detect rotation, rotational movement, angular displacement, tilt, position, orientation, motion along a non-linear (e.g., arcuate) path, or any other non-linear motions. Additionally or alternatively, sensor 15 may include one or more angular rate, inertial, and/or gyro-motion sensors or gyroscopes for detecting rotational movement. For example, sensor 15 may include one or more rotating or vibrating elements, optical gyroscopes, vibrating gyroscopes, gas rate gyroscopes, ring gyroscopes, magnetometers (e.g., scalar or vector magnetometers), compasses, and/or the like. Any other suitable sensors may also or alternatively be provided by sensor 15 for detecting motion on device 120, such as any suitable pressure sensors, altimeters, or the like. Using sensor 15, device 120 may be configured to determine a velocity, acceleration, orientation, and/or any other suitable motion attribute of device 120. One or more biometric sensors may be multi-modal biometric sensors and/or operative to detect long-lived biometrics, modern liveness (e.g., active, passive, etc.) biometric detection, and/or the like. Sensor 15 may include a microphone, camera, scanner (e.g., a barcode scanner or any other suitable scanner that may obtain product identifying information from a code, such as a linear barcode, a matrix barcode (e.g., a quick response (“QR”) code), or the like), proximity sensor, light detector, temperature sensor, motion sensor, biometric sensor (e.g., a fingerprint reader or other feature (e.g., facial) recognition sensor, which may operate in conjunction with a feature-processing application that may be accessible to device 120 for attempting to authenticate a user), line-in connector for data and/or power, and/or combinations thereof. In some examples, each sensor can be a separate device, while, in other examples, any combination of two or more of the sensors can be included within a single device. For example, a gyroscope, accelerometer, photoplethysmogram, galvanic skin response sensor, and temperature sensor can be included within a wearable electronic device, such as a smart watch, while a scale, blood pressure cuff, blood glucose monitor, SpO2 sensor, respiration sensor, posture sensor, stress sensor, and asthma inhaler can each be separate devices. While specific examples are provided, it should be appreciated that other sensors can be used and other combinations of sensors can be combined into a single device. Device 120 can further include a timer that can be used, for example, to add time dimensions to various attributes of any detected element(s). Sensor 15 may include any suitable sensor components or subassemblies for detecting any suitable characteristics of any suitable condition of the lighting of the environment of device 120. For example, sensor 15 may include any suitable light sensor that may include, but is not limited to, one or more ambient visible light color sensors, illuminance ambient light level sensors, ultraviolet (“UV”) index and/or UV radiation ambient light sensors, and/or the like. Any suitable light sensor or combination of light sensors may be provided for determining the illuminance or light level of ambient light in the environment of device 120 (e.g., in lux or lumens per square meter, etc.) and/or for determining the ambient color or white point chromaticity of ambient light in the environment of device 120 (e.g., in hue and colorfulness or in x/y parameters with respect to an x-y chromaticity space, etc.) and/or for determining the UV index or UV radiation in the environment of device 120 (e.g., in UV index units, etc.). Sensor 15 may include any suitable sensor components or subassemblies for detecting any suitable characteristics of any suitable condition of the air quality of the environment of device 120. For example, sensor 15 may include any suitable air quality sensor that may include, but is not limited to, one or more ambient air flow or air velocity meters, ambient oxygen level sensors, volatile organic compound (“VOC”) sensors, ambient humidity sensors, ambient temperature sensors, and/or the like. Any suitable ambient air sensor or combination of ambient air sensors may be provided for determining the oxygen level of the ambient air in the environment of device 120 (e.g., in O₂% per liter, etc.) and/or for determining the air velocity of the ambient air in the environment of device 120 (e.g., in kilograms per second, etc.) and/or for determining the level of any suitable harmful gas or potentially harmful substance (e.g., VOC (e.g., any suitable harmful gasses, scents, odors, etc.) or particulate or dust or pollen or mold or the like) of the ambient air in the environment of device 120 (e.g., in HG % per liter, etc.) and/or for determining the humidity of the ambient air in the environment of device 100 (e.g., in grams of water per cubic meter, etc. (e.g., using a hygrometer)) and/or for determining the temperature of the ambient air in the environment of device 120 (e.g., in degrees Celsius, etc. (e.g., using a thermometer)). Sensor 15 may include any suitable sensor components or subassemblies for detecting any suitable characteristics of any suitable condition of the sound quality of the environment of device 120. For example, sensor 15 may include any suitable sound quality sensor that may include, but is not limited to, one or more microphones or the like that may determine the level of sound pollution or noise in the environment of device 120 (e.g., in decibels, etc.). Sensor 15 may also include any other suitable sensor for determining any other suitable characteristics about a user of device 120 and/or the environment of device 120 and/or any situation within which device 120 may be existing. For example, any suitable clock and/or position sensor(s) may be provided to determine the current time and/or time zone within which device 120 may be located. Sensor 15 may be embedded in a body (e.g., housing 11) of device 120, such as along a bottom surface that may be operative to contact a user, or can be positioned at any other desirable location. In some examples, different sensors can be placed in different locations inside or on the surfaces of device 120 (e.g., some located inside housing 11 and some attached to an attachment mechanism (e.g., a wrist band coupled to a housing of a wearable device), or the like). In other examples, one or more sensors can be worn by a user separately as different parts of a single device 120 or as different devices. In such cases, the sensors can be configured to communicate with device 120 using a wired and/or wireless technology (e.g., via communications component 14). In some examples, sensors can be configured to communicate with each other and/or share data collected from one or more sensors.

Power supply 17 can include any suitable circuitry for receiving and/or generating power, and for providing such power to one or more of the other components of device 120. For example, power supply assembly 17 can be coupled to a power grid (e.g., when device 120 is not acting as a portable device or when a battery of the device is being charged at an electrical outlet with power generated by an electrical power plant). As another example, power supply assembly 17 may be configured to generate power from a natural source (e.g., solar power using solar cells). As another example, power supply assembly 17 can include one or more batteries for providing power (e.g., when device 120 is acting as a portable device). Device 120 may also be provided with a housing 11 that may at least partially enclose one or more of the components of device 120 for protection from debris and other degrading forces external to device 120. Each component of device 120 may be included in the same housing 11 (e.g., as a single unitary device, such as a portable media device or server) and/or different components may be provided in different housings (e.g., a keyboard input component may be provided in a first housing that may be communicatively coupled to a processor component and a display output component that may be provided in a second housing, such as in a desktop computer set-up). In some embodiments, device 120 may include other components not combined or included in those shown or several instances of the components shown.

Processor 12 may be used to run one or more applications, such as an application 19 that may be accessible from memory 13 (e.g., as a portion of data 19d) and/or any other suitable source (e.g., from any other device in its system). Application 19 may include, but is not limited to, one or more operating system applications, firmware applications, communication applications (e.g., for enabling communication of data between devices), third party service applications, internet browsing applications (e.g., for interacting with a website provided by a third party subsystem (e.g., a device 118 with a network device 100-116)), application programming interfaces (“APIs”), software development kits (“SDKs”), CURATED applications (e.g., a web application or a native application for enabling device 120 to interact with an online service and/or one or more data devices 118 and/or the like, which may include applications for routing protocols, SDN modules based on OpenFlow, P4, or other network data plane programming standards, machine learning algorithms, network management functions, etc.), any other suitable applications, and/or the like. For example, processor 12 may load an application 19 as an interface program to determine how instructions or data received via an input component of I/O component 16 or other component of device 120 (e.g., sensor 15 and/or communications component 14) may manipulate the way in which information may be stored (e.g., in memory 13) and/or provided to via an output component of I/O component 16 and/or to another system device via communications component 14. As one example, application 19 may be a third party application that may be running on device 120 (e.g., an application associated with the network of system 1 and/or data device 118) that may be loaded on device 120 (e.g., using communications component 14) via an application market, such as the Apple App Store or Google Play, or that may be accessed via an internet application or web browser (e.g., by Apple Safari or Google Chrome) that may be running on device 120 and that may be pointed to a uniform resource locator (“URL”) whose target or web resource may be managed by or otherwise affiliated with any suitable entity. Any device (e.g., any router device or controller device of a network) may include any suitable special purpose hardware (e.g., hardware support of high-speed packet processing, hardware support of machine learning algorithms, hardware support of Boolean Satisfiability computation, etc.).

Device 120 may be any portable, mobile, wearable, implantable, or hand-held electronic device configured to operate with system 1. Alternatively, device 120 may not be portable during use, but may instead be generally stationary. Device 120 can include, but is not limited to, a media player, video player, still image player, game player, other media player, music recorder, movie or video camera or recorder, still camera, other media recorder, radio, medical equipment, domestic appliance, smart appliance (e.g., smart door knob, smart door lock, etc.), transportation vehicle instrument, musical instrument, calculator, cellular telephone, other wireless communication device, personal digital assistant, remote control, pager, computer (e.g., a desktop, laptop, tablet, server, etc.), monitor, television, stereo equipment, set up box, set-top box, wearable device (e.g., an Apple Watch™ by Apple Inc.), boom box, modem, router, printer, kiosk, beacon, server, and any combinations thereof that may be useful as a node of a network (e.g., devices 100-116) and/or as a data device (e.g., device 118).

One or more routing algorithms or processes may be provided for computing a set of routes in a network that provide a full range of performance from a source node to a destination node. Certain routing algorithms may be precomputed (e.g., in advance of any particular packet or flow being transmitted onto the network rather than computed on-demand with each new packet or flow).

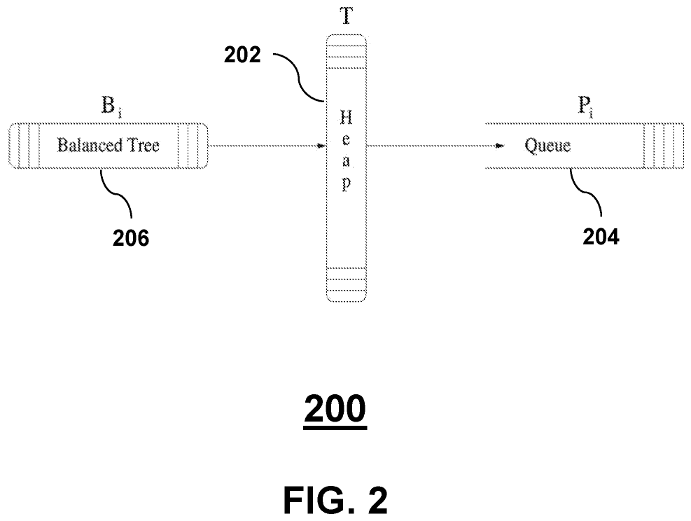

One or more routing algorithms may be based on a data structure model, such as data structure model 200 of FIG. 2. As shown, structure 200 may include a balanced tree 206 (Bk) that may be maintained for each node in a graph to hold newly discovered, temporary labeled routes for that node. A heap 202 (T) may contain a lightest weight entry from each non-empty Bᵢ (e.g., for a maximum of n entries). A queue 204 (Pᵢ) may be maintained for each node that contains a set of permanently labeled routes (e.g., as discovered by the algorithm), for example, in the order in which they are discovered (e.g., which may be in increasing weight).

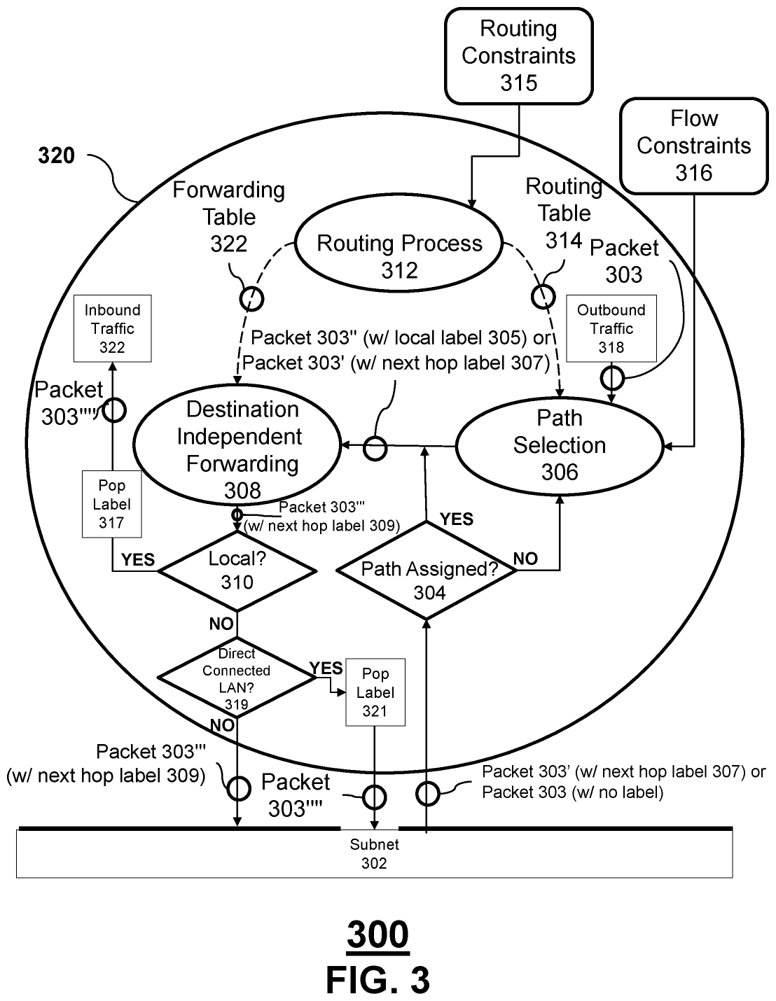

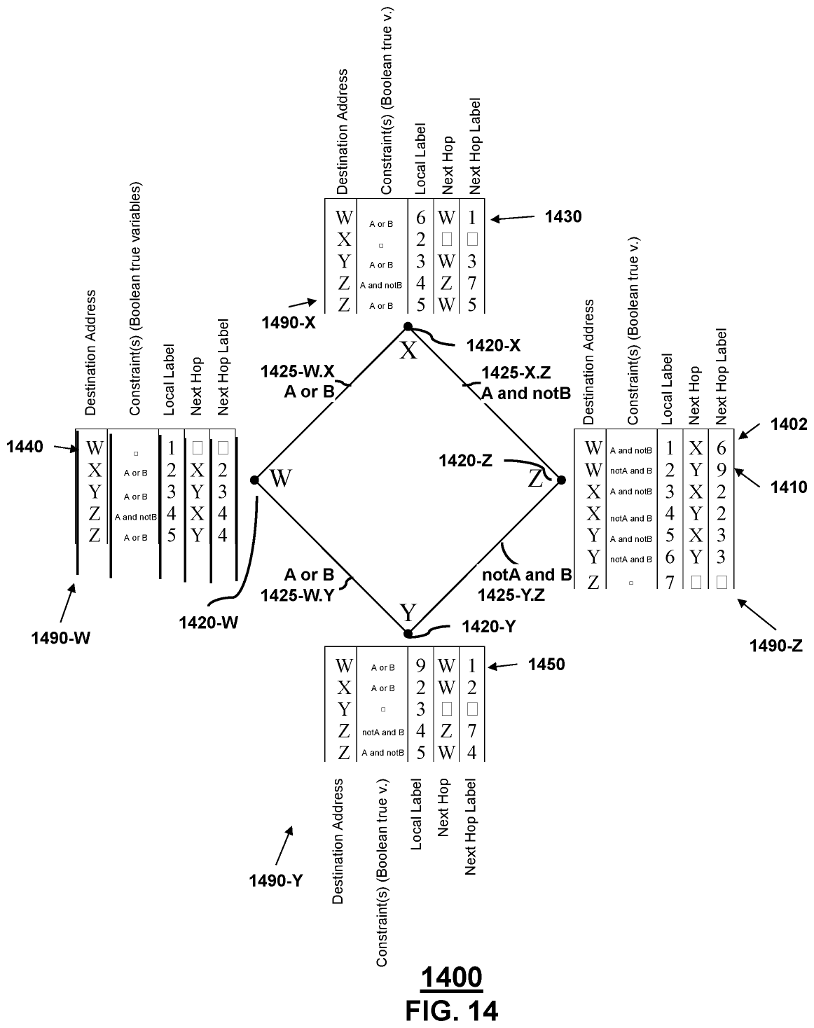

After multiple routes may be computed, the computed routes may be used for routing flows. For a given flow associated with at least one policy constraint that may be specified by a Boolean expression, a route may be selected from the set of multiple computed routes such that the selected route may satisfy the policy constraint(s) for the flow. The packets of the flow may be forwarded in accordance with the selected route. Performing traffic classification at each hop in the network may be prohibitively expensive. To avoid this, certain routing algorithms may use label-swap forwarding so that only a first router that handles a packet may need to perform a traffic classification before forwarding it. Accordingly, the forwarding state of a router may be enhanced to include local and next hop forwarding label information, in addition to the destination and next hop information that may exist in traditional forwarding tables, as may be shown in the tables of FIGS. 11 and 14. Traffic classifiers may be placed at the edge of an internet, where “edge” may be defined to be any point from which traffic can be injected into the internet. FIG. 3 illustrates schematically aspects of an illustrative packet processing process 300 (e.g., a process of routing and classification of traffic flows) by a router device 320 that may be coupled to any suitable internet subnet 302 (e.g., as a communication from another node or host or the like). Packet processing process 300 may include router device 320 checking at operation 304 if a packet 303 communicated from subnet 302 has an assigned path. If it is determined at operation 304 that packet 303 does not have an assigned path, then router device 320 may select a path at any suitable path selection operation(s) 306 (e.g., by applying a traffic classifier) or router device 320 may select a path at any suitable path selection operation(s) 306 for any suitable outbound traffic 318 (e.g., if the packet to be processed is sourced at router device 320 (e.g., when router device 320 may be the source node)). As shown, operation(s) 306 may be configured to receive and/or access and/or be informed by and/or otherwise utilize any suitable data for selecting a path, including, but not limited to, one or more routing tables 314 from any suitable routing process operation(s) 312, any suitable flow constraint(s) 316 that may be identified for the packet's flow, and/or the like. Path selection operation(s) 306 may be operative to identify a local label 305 for packet 303 associated with the selected path. Then, after any suitable path selection at operation(s) 306 or if it is determined at operation 304 that the packet does have an assigned path (e.g., when router device 320 may be an intermediate node between a source node and a destination node where device 320 may receive packet 303′ with a next hop label 307), any suitable destination independent forwarding operation(s) 308 may be applied to the packet (e.g., to a packet 303″ (e.g., packet 303 with local label 305) as may be provided by operation 306 or to a received packet 303′ with label 307). As shown, operation(s) 308 may be configured to receive and/or access and/or be informed by and/or otherwise utilize any suitable data for destination independent forwarding, including, but not limited to, one or more forwarding tables 322 from any suitable routing process operation(s) 312, and/or the like, for potentially swapping the label of the packet with an appropriately identified next hop label, such as for providing a packet 303′″ (e.g., packet 300 with identified next hop label 309 rather than local label 305 or packet 300′ with identified next hop label 309 rather than received next hop label 307). Packet processing process 300 may then include router device 320 checking at operation 310 if the packet with next hop label is local (e.g., if new label 309 does not exist or if next hop label 307 may identify the current router as the destination). If it is determined at operation 310 that the packet is not local, router device 320 may determine if the packet is to be sent to a direct connected LAN, and, if not, the packet may be forwarded as packet 303′″ (a packet with next hop label 309) back onto subnet 302 (e.g., for communication to a next node), and, if so, new label 309 may be popped off the packet at operation 321 and the packet may be forwarded (e.g., as processed packet 303″″ (e.g., a packet without a next hop label)) back onto subnet 302. However, if it is determined at operation 310 that the packet is local, new label 309 (if any) or old label 307 (if still in tact) may be popped off the packet at operation 317 and router device 320 may provide the packet (e.g., as processed packet 303″″ (e.g., a packet without a next hop label)) for inbound traffic 322 (e.g., for further processing at router device 320 (e.g., when router device 320 may be the destination node)).

The operations shown in process 300 of FIG. 3 are only illustrative and that existing operations may be modified or omitted, additional operations may be added, and the order of certain operations may be altered.

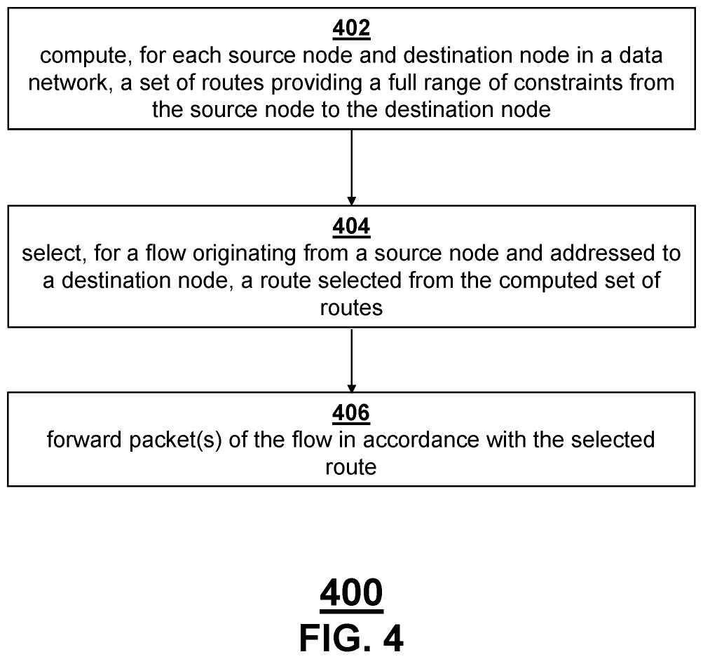

FIG. 4 is a flowchart of an illustrative process 400 for packet routing. At operation 402, any suitable component(s) or equipment of or associated with a data network may compute, for each source node in the data network and for each destination node in the data network, a set of routes or paths that may provide a full and/or desired range of constraints (e.g., performance constraints and/or policy constraints and/or service chaining constraints, etc.) that may be available in the network from the source node to the destination node (e.g., operation 312 of process 300 based on any suitable routing constraints 315). At operation 404, any suitable component(s) or equipment of or associated with the data network may select, for a flow (e.g., a sequence or set or stream of packets that may satisfy or be subject to the same set of constraints) that may be originating from a source node and that may be addressed to a destination node, a route selected from the computed set of routes (e.g., the set of routes computed at operation 402 for the source node and the destination node of the flow) (e.g., selection operation(s) 306 of process 300). The selected path may be used for forwarding all packets of the flow according to the configured flow constraints of the flow. This path selection may be implemented, for example, using an oracle that may always assign a flow to a path that both satisfies the flow's QoS requirements and has adequate available bandwidth for the flow. For example, this path selection may be carried out at the source node of the flow using any suitable information available to that source node (e.g., one or more routing tables 314 from any suitable routing process operation(s) 312, any suitable flow constraint(s) 316, and/or the like). At operation 406, any suitable component(s) or equipment of or associated with a data network may forward the flow (e.g., one, some, or each packet of the flow) in accordance with the route selected at operation 404 (e.g., forwarding operation(s) 308 of process 300).

The operations shown in process 400 of FIG. 4 are only illustrative and that existing operations may be modified or omitted, additional operations may be added, and the order of certain operations may be altered.

Label-swapping may be used in the context of connection-oriented (e.g., virtual circuit) packet forwarding architectures. In such applications, a connection setup phase may establish the labels that routers should use to forward packets carrying such labels, where a label may refer to an active source-destination connection. Another technique that may be used is the technique of threaded indices, in which neighboring routers may share labels corresponding to indexes into their routing tables for routing-table entries for destinations, and such labels may be included in packet headers to allow rapid forwarding-table lookups. Certain forwarding labels that may be used according to one or more processes of this disclosure may be similar in some aspects to threaded indices. For example, a label may be assigned to each routing-table entry, and each routing-table entry may correspond to a policy-based route that may be maintained for a given destination. Consequently, for each destination, a router may exchange one or multiple labels with its neighbors. Each label may be assigned to a destination that may correspond to a set of service classes that may be satisfied by the route identified by the label.

A forwarding architecture that may be used according to one or more processes of this disclosure may be implemented, for example, using a downstream tag allocation method, which may be described in Cisco's Tag Switching Architecture. In downstream tag allocation, routers may allocate tags as a part of a routing computation, where a tag may be assigned to each forwarding table entry. The binding of these tags with routes may then be advertised to adjacent routers that support tag switching. Routers can use the tag information to construct their own Tag Information Base, which may be used for label-swap forwarding.

In addition to or as an alternative to BCMR being implemented with labels, it may be implemented with source routing in general, and segment routing in particular. In some embodiments, selecting the route may include, if a source route is not present in a packet, computing the source route from traffic classification rules that may be specified in terms of contents of the packet, in terms of a user associated with the packet, in terms of a port the packet arrives on, and/or in terms of one or more other environmental factors. If a source route is already present in a packet, the forwarding may include forwarding the packet based on the source route in the packet.

In some embodiments, selecting the route may include, if a segment list is not present in the packet, computing the segment list from traffic classification rules specified in terms of contents of the packet, in terms of a user associated with the packet, in terms of a port the packet arrives on, and/or in terms of one or more other environmental factors. If a segment list is already present in the packet, the forwarding may include forwarding the packet based on the segment list in the packet.

Various Boolean Constrained Multipath Routing (BCMR) algorithms may be provided. Table 1 may define a notation that may be used in one or more of the algorithms, and Table 2 may define the primitive operations for queues, heaps, and balanced trees that may be used in one or more of the algorithms, and may give their time complexity used in their complexity analysis. Algorithm 1 may be a listing of a modified Dijkstra algorithm that may compute a set of shortest routes to each destination that may satisfy all truth assignments for the Boolean algebra available from a path in the network. Algorithm 2 may extend such an algorithm to compute a maximal set of routes for each satisfiable truth assignment in the network.

The SAT(φ) primitive of the traffic algebra may be the satisfiability problem of traditional Boolean algebra. SAT may answer the question “is there an assignment of truth values to the propositional variables in φ such that φ evaluates to true?”. The SAT(φ) primitive may evaluate to 1 (true) if such a truth assignment exists, and 0 (false) otherwise. Satisfiability may be tested in two situations by one or more of the algorithms described herein. First, when a new route to a destination may be considered for comparison to an existing route for the same destination, they may be only compared if classes of traffic exist that can use either route. Therefore, new routes may be only compared with existing routes when the conjunction of their path predicates is satisfiable. Second, given that classes of traffic exist that can use either path, the algorithm(s) may determine whether all traffic supported by one path could use the other. This may be the case if the path predicate for one path implies (“→”) the other or, more precisely, if the expression (εₓ→ε_{y}) is always true (i.e., is valid). Determining if an expression is valid may be equivalent to determining if the negation of the expression is unsatisfiable. Therefore, the expressions of the form ε₁→ε₂ may be equivalent to ¬SAT(¬(ε₁→ε₂)) (or ¬SAT(ε₁∧¬ε₂)). The satisfiability decision performed by SAT(ε) may be a prototypical NP-complete problem. As may be typical with NP-complete problems, it may have many restricted versions that may be computable in polynomial time.

In the DSMR elements of Algorithm 2, path weights may be composed of multi-component metrics that may capture one, some, or all important performance measures of a link, such as delay, delay variance (“jitter”), available bandwidth, and/or the like. A best set of paths to a destination may be defined using an enhanced version of the path algebra defined by Sobrinho (“IEEE/ACM Transactions on Networking,” 10(4):541-550, August 2002).

Formally, path algebra P=<W, ⊕, [symbol] , [symbol] , 0, ∞> may be defined as a set of weights W, with a binary operator ⊕, and two order relations, [symbol] and [symbol] , defined on W. There may be two distinguished weights in W, 0 and ∞, that may represent the least and absorptive elements of W, respectively. Operator ⊕ may be the original path composition operator, and relation [symbol] may be the original total ordering of Sobrinho, which may be used to order the paths for traversal by a path selection algorithm. Operator ⊕ may be used to compute path weights from link weights. A routing algorithm may use relation [symbol] to build a forwarding set, starting with a minimal element, and by a forwarding process to select a minimal element of the forwarding set whose parameters may satisfy a given QoS request. A new relation on routes, may be added to the algebra and may be used to define classes of comparable routes and/or select maximal elements of these classes for inclusion in the set of forwarding entries for a given destination. Relation [symbol] may be a partial ordering (e.g., reflexive, anti-symmetric, and transitive) with the following, additional property (Property 1):

Property 1 (ωₓ [symbol] ω_{y})⇒(ωₓ [symbol] ω_{y}).
An example path algebra based on weights composed of delay and bottleneck bandwidth may be as follows:
ω≡(dᵢ,bᵢ)
0≡(0,∞)
∞≡(∞,0)
ωᵢ⊕ωⱼ≡(dᵢ+dⱼ, Min(bᵢ,bⱼ))
ωᵢ [symbol] ωⱼ≡(dᵢ<dⱼ)∨((dᵢ=dⱼ)∧(bᵢ≥bⱼ))
ω [symbol] ωⱼ≡(dⱼ≤dᵢ)∧(bⱼ≥bᵢ)

TABLE 1
Notation.

A(i) ≡ Set of edges adjacent to i in the graph.
ωᵢⱼ ≡ Weight of edge (i, j).
εᵢⱼ ≡ Link predicate of edge (i, j).
P ≡ Queue of permanent routes to all nodes.
Pₙ ≡ Queue of permanent routes to node n.
T ≡ Heap of temporary routes.
Tₙ ≡ Entry in T for node n.
Bₙ ≡ Balanced tree of routes for node n.
Eₙ ≡ Summary of traffic expression for all routes in Pₙ.

TABLE 2
Operations on Data Structures.

| | |
|---|---|
| Queue | |
| Push(r, Q) | Insert record r at tail of queue Q |
| Head(Q) | Return record at head of queue Q |
| Pop(Q) | Delete record at head of queue Q |
| PopTail(Q) | Delete record at tail of queue Q |
| d-Heap | |
| Insert(r, H) | Insert record r in heap H |
| IncreaseKey(r, rₕ) | Replace record rₕ in heap with record r |
| | having greater key value |
| DecreaseKey(r, rₕ) | Replace record rₕ in heap with record r |
| | having lesser key value |
| Min(H) | Return record in heap H with smallest key value |
| DeleteMin(H) | Delete record in heap H with smallest key value |
| Delete(rₕ) | Delete record rₕ from heap |
| Balanced Tree | |
| Insert(r, B) | Insert record r in tree B |
| Min(B) | Return record in tree B with smallest key value |
| DeleteMin(B) | Delete record in tree B with smallest key value |

Algorithm 1: Modified Dijkstra SPF algorithm for BCMR.

```
algorithm BCMR
begin
Push(<s,s,0,1>, Ps);
for each {(s, j) ∈ A(s)}
  Insert(<j,s,ωₛⱼ,εₛⱼ>, T);
while(|T|>0)
  begin
  <i,pᵢ,ωᵢ,εᵢ> ← Min(T);
  DeleteMin(Bᵢ);
  if(|Bi| = 0)
    then DeleteMin(T)
    else IncreaseKey(Min(Bᵢ), Tᵢ);
  if (¬(εᵢ → Eᵢ))
    then begin
      Push(<i,pᵢ,ωᵢ,εᵢ>, Pᵢ);
      Eᵢ ← Ei∨εi;
      for each {(i,j) ∈ A(i) | SAT(εᵢ Λεᵢⱼ) Λ ¬((εᵢ Λεᵢⱼ) → Eⱼ)}
        begin
        ωⱼ ← ωᵢ + ωᵢⱼ;εⱼ ← εᵢ Λεᵢⱼ;
        if (Tⱼ = Ø)
          then Insert(<j,i,ωⱼ,εⱼ>, T)
        else if (ωⱼ < Tⱼ.ω)
          then DecreaseKey(<j,i,ωⱼ,εⱼ>, T);
        Insert(<j,i,ωⱼ,εⱼ>, Bⱼ);
        end
      end
  end
end
```

Algorithm 2: Modified Dijkstra SPF
algorithm for combined DSMR & BCMR.

```
algorithm Combined DSMR & BCMR
begin
Push(<s,s,0,1>, Pₛ);
for each {(s, j) ∈ A(s)}
  Insert(<j,s,ωₛⱼ,εₛⱼ>, T);
while(|T|>0)
  begin
  <i,pᵢ,ωᵢ,εᵢ > ← Min(T);
  DeleteMin(Bᵢ);
  if(|Bᵢ| = 0)
    then DeleteMin(T)
    else IncreaseKey(Min(Bᵢ), Tᵢ);
  εₜₘₚ ← εᵢ; ptr ← Tail(Pᵢ);
  while ((εₜₘₚ /= 0) Λ (ptr /= Ø))
    if (ωi ⊏ ptr.ω)
      εₜₘₚ ← εₜₘₚ Λ ¬ptr.ε; ptr ← ptr.next;
  if(εₜₘₚ ≠ 0)
    then begin
      Push(<i,pᵢ,ωᵢ,εᵢ>, Pᵢ);
      for each{(i,j) ∈ A(i) | SAT(εₜₘₚ Λεᵢⱼ)}
        begin
        ωⱼ ← ωᵢ ⊕ ωᵢⱼ;εⱼ ← εₜₘₚΛεᵢⱼ;
        if (Tⱼ = Ø)
          then Insert(<j,i,ωⱼ,εⱼ>, T)
        else if (ωⱼ [symbol]   Tⱼ.ω)
          then DecreaseKey(<j,i,ωⱼ,εⱼ>, T);
        Insert(<j,i,ωⱼ,εⱼ>, Bⱼ);
        end
      end
  end
end
```

Dijkstra may not be needed but is just an example of a method that could be used to reach all nodes, where other examples may include, but are not limited to, Bellman Ford and any other shortest path routing algorithms, where, although need not be limited to shortest path first specifically, but those may work.

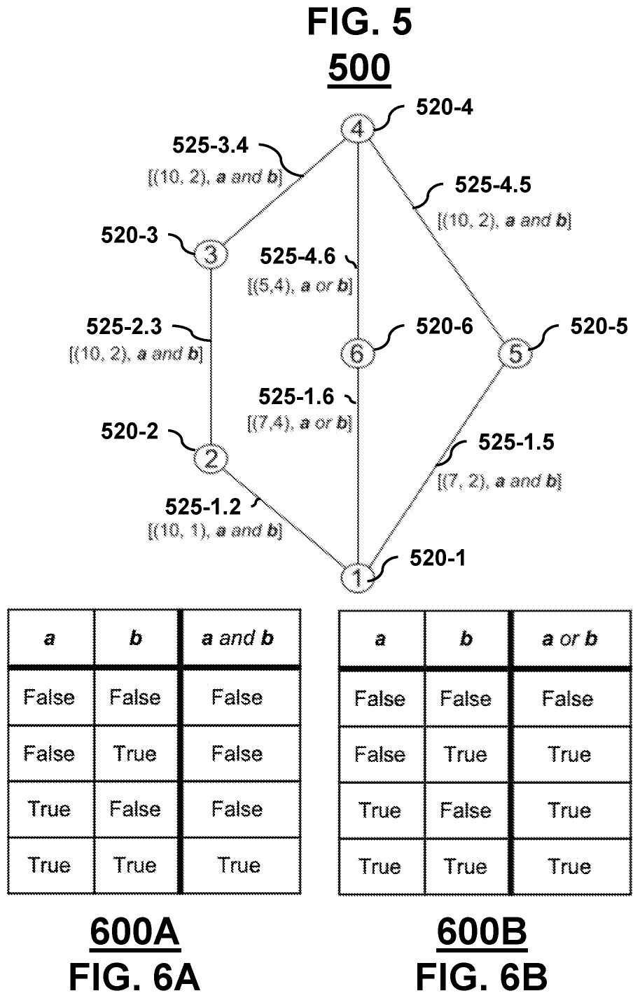

FIG. 5 shows at least a portion of a network 500 that may include any suitable number of nodes or router devices 520 (e.g., node 520-1, node 520-2, node 520-3, node 520-4, node 520-5, and node 520-6), where different nodes may be communicatively coupled to one another (e.g., using communication components of the nodes) over different communication links 525 (e.g., link 525-1.2 between nodes 520-1 and 520-2, link 525-1.5 between nodes 520-1 and 520-5, link 525-1.6 between nodes 520-1 and 520-6, link 525-2.3 between nodes 520-2 and 520-3, link 525-3.4 between nodes 520-3 and 520-4, link 525-4.5 between nodes 520-4 and 520-5, and link 525-4.6 between nodes 520-4 and 520-6), and where each link may be associated with specific example constraints (e.g., performance constraints and/or policy constraints and/or service chaining constraints, etc.). For example, as shown, certain (e.g., two) constraints or measures (e.g., performance constraints or performance measures, etc.) of a link may be provided as a link weight (e.g., as “bandwidth, delay” link weight(s)), and each link may be provided with at least one Boolean constraint (e.g., as a policy constraint, etc.) that may be defined by any suitable Boolean expression that may be composed of any suitable Boolean variable(s) (e.g., Boolean variable “a” and Boolean variable “b”, although any additional or alternative Boolean variable(s) and/or Boolean constraints may be associated with one, some, or each link), which may be used to express a constraint of flows using the network. As just some specific examples of constraints with a “bandwidth, delay” link weight constraint and a “Boolean expression (a, b)” Boolean constraint, link 525-1.2 may include constraints [(10, 1), a and b], link 525-1.5 may include constraints [(7, 2), a and b], link 525-1.6 may include constraints [(7, 4), a or b], link 525-2.3 may include constraints [(10, 2), a and b], link 525-3.4 may include constraints [(10, 2), a and b], link 525-4.5 may include constraints [(10, 2), a and b], and link 525-4.6 may include constraints [(5, 4), a or b]. In this portion of network 500, a number of hops between two particular nodes 520 may vary amongst different paths of one or more links 525, and each link may or may not satisfy a particular Boolean test. Routing based on just one Boolean test per device may not be suitable for all application types.

As shown in FIG. 5, various paths may exist between nodes 520-1 and 520-4, including a first path (1,2,3,4) that may include links 525-1.2, 525-2.3, and 525-3.4, each of which may have a Boolean constraint defined by a Boolean expression “a and b”, a second path (1,5,4) that may include links 525-1.5 and 525-4.5, each of which may have a Boolean constraint defined by a Boolean expression “a and b”, and a third path (1,6,4) that may include links 525-1.6 and 525-4.6, each of which may have a Boolean constraint defined by a Boolean expression “a or b”. Although not shown, it is to be understood that another path may exist where different links of the path may have different Boolean constraints (e.g., a path (1,6,3,4) where a link from node 520-6 to node 520-3 (not shown) may have a Boolean constraint defined by a Boolean expression “a and b”, and such a path may be computed for a routing table at node 520-1 if the path is computed to be a best set of paths for a particular non-dominated path). A truth table 600A of FIG. 6A identifies the possible combinations of Boolean variable values for the Boolean variables a and b and associated Boolean expression results (e.g., functional values) for the Boolean expression “a and b” (e.g., of the Boolean constraint of links 525-1.2, 525-2.3, 525-3.4, 525-1.5, and 525-4.5), while a truth table 600B of FIG. 6B identifies the possible combinations of Boolean variable values for the Boolean variables a and b and associated Boolean expression results (e.g., functional values) for the Boolean expression “a orb” (e.g., of the Boolean constraint of links 525-1.6 and 525-4.6).

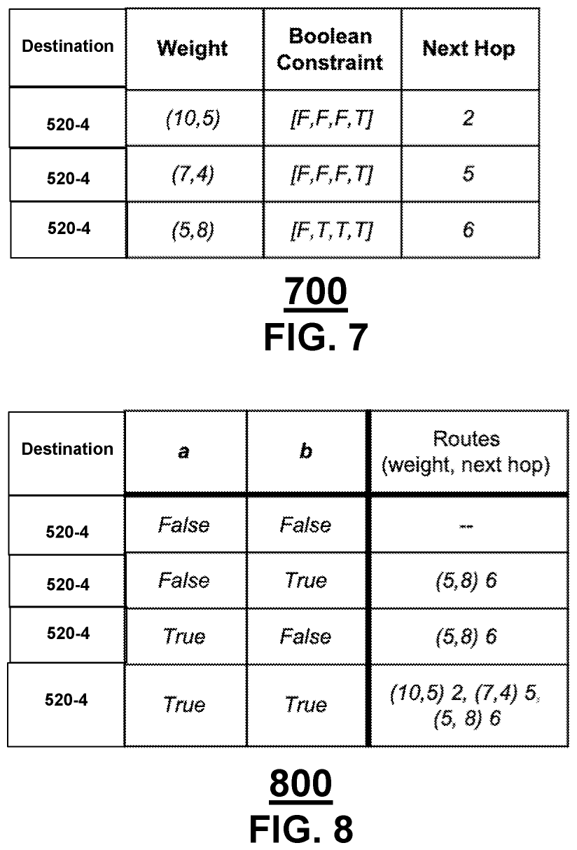

Given such first path (1,2,3,4), second path (1,5,4), and third path (1,6,4), a combined DSMR and BCMR routing algorithm (e.g., Algorithm 2) may be configured to compute a data structure 700 of FIG. 7 that may be indicative of at least a portion of a routing table (e.g., routing table 314 of FIG. 3) for node 520-1, which may indicate a routing table entry row for each of the three paths from that node 520-1 to destination node 520-4 with weight constraint, Boolean constraint, and next hop for the applicable path (e.g., where the weights may be (bandwidth, delay) and the path algebra may be Shortest-Widest). A data structure 800 of FIG. 8 may be indicative of the truth assignments to Boolean variables in the Boolean constraints of the different paths (e.g., data structure 800 may show for each of the possible truth assignments of the Boolean variable values for the Boolean variables a and b, the different routes available between node 520-1 and node 520-4 (e.g., weights and next hop)). For example, in data structure 700, the list in the Boolean Constraint column may be a shorthand version of truth tables 600A and 600B. Specifically, “F” and “T” may respectively represent False and True, and each entry in the list may represent the corresponding entry in the associated truth table (e.g., the first entry in the list may be the Boolean variable value for a=False and b=False, the second entry is for a=False and b=True, etc.). These entries may be interpreted in terms of a (e.g., logically) distinct table for each truth assignment to the variables used in the constraints. This interpretation can be visualized by the table of data structure 800.

As an example, a flow with the constraint “a and b”, and, thus the truth table result column [F,F,F,T], can use routes for any of the satisfying truth assignments of a and b. Entries in the Routes column may be in the format “(bandwidth, delay) next hop”. Translating this to usable routes, this flow can use any of the available paths. Concretely, the entry for [a=F, b=F] is empty (“--”), the entry for [a=F, b=T] is “(5,8) 6”, the entry for [a=T, b=F] is “(5,8) 6”, and the entry for [a=T, b=T] is “(10,5) 2, (7,4) 5, (5,8) 6” for the following list of usable routes: first path (1,2,3,4)=(10,5) 2, second path (1,5,4)=(7,4) 5, and third path (1,6,4)=(5,8) 6.

However, given there are 2ⁿ rows in such a truth assignment table (e.g., 2 routing tables to search for a given flow constraint), where n is the number of constraint variables, this approach to forwarding table lookups may be prohibitively expensive. Therefore, an alternative solution is suggested by the observation that the set of usable routes for a given flow may be those where the performance constraint is satisfied, and both the routing table constraint and the flow constraint evaluate to True. This may be exactly the set of routing table entries where the performance constraint is satisfied (e.g., if RT_{pc} is the routing table performance constraint and F_{pc} is the flow performance constraint, the entries where “F_{pc} [symbol] RT_{pc}”), and the conjunction of the routing table constraint and the flow constraint is satisfiable, therefore, if RT_{bc} is the routing table constraint (e.g., “Boolean Constraint” in the routing table above) and F_{bc} is the flow performance constraint (e.g., the truth table [T,T,F,T] representing the constraint “not a and b” above), then the set of usable routes may be those where SAT(“RT_{bc} and F_{bc}”) is True (e.g., where SAT( ) is the standard Boolean Satisfiability function).

This may be described in the following pseudo-code, where R_{d} may be the set of routes computed for destination d containing routes of the form <dest, next hop, forwarding information, performance constraint, Boolean constraint>, where forwarding information may be the information used to forward the traffic, such as label swap information:

```
algorithm ForwardingSet(R_{d}, F_{pc}, F_{bc})
begin
FS ← { }; // The computed forwarding set.
for each {<d, nh, fi, pc, bc> ∈ R_{d}}
  if (F_{pc} ⊏ RT_{pc} and SAT(RT_{bc} and F_{bc}))
    then Append (<d, nh, fi>, FS)
return (FS)
end
```

This algorithm may provide an efficient, single pass solution for identifying candidate paths for the flow. The returned set of routes may be those that satisfy the constraints, where one of these can be selected based on other criteria, such as minimal congestion, for use by the given flow.

A communication model of this disclosure may use the “best set of paths” to address performance and policy problems. The best set of paths may be computed from source to destination (e.g., for each router in a network (e.g., subject to partial ordering)). This set of paths may satisfy the full range of performance capabilities and policy constraints available in the network. Traffic then may be forwarded on the least congested path satisfying the performance and policy requirements that apply to the traffic. Simulations show that this communication model may increase network capacity 10-fold. Benefits of this architecture may include, but are not limited to, a default-closed network model and support for zero-trust networking, network segmentation, tiered service levels, and/or the like.

Such a communication model may work with existing Internet infrastructure and can be implemented at layer 2 (e.g., as a software-defined networking (“SDN”) module) or layer 3 (e.g., as enhancements to distributed routing protocols). Such a communication model may be packaged as an enhanced networking solution that may be targeted for different environments, such as organizational, ISP, high security (e.g., military) networks, and/or the like.

A 2004 paper titled “Efficient Policy-Based Routing Without Virtual Circuits” by Bradley R. Smith and JJ Garcia-Luna-Aceves, which is hereby incorporated by reference herein in its entirety, provides an overview to core results from a 2003 dissertation titled “Efficient-Policy-Based Routing In The Internet” by Bradley R. Smith, which is also hereby incorporated by reference herein in its entirety. These references present general models of using a “best set” of paths and give algorithms for computing the set of paths that may satisfy both performance and policy constraints. Moreover, routing in the context of performance constraints may be combined with selecting the least congested path from a subset of the “best set” that satisfies the performance requirement of a given flow, for example, as may be described in U.S. Pat. No. 9,197,544 by Bradley R. Smith, which is also hereby incorporated by reference herein in its entirety.

Multiprotocol label swapping (“MPLS”) labels may be used for forwarding over multiple paths per destination in an efficient manner (e.g., for an implementation of this communication model (e.g., for a prototype implementation of these algorithms)).

An Internet routing model may be based on a single best path between source and destination. This model may be limited in its ability to support diverse performance and policy requirements. These limitations may be mitigated through the development of the MPLS technology. MPLS may enhance the Internet forwarding architecture by replacing the use of destination addresses for forwarding traffic, to the use of local (e.g., to the network device) labels. Among a number of benefits, this additional layer of abstraction may allow for efficient forwarding of traffic over multiple paths from source to destination.

To exploit the efficient capabilities of an MPLS data plane, a number of signaling protocols may distribute MPLS label information and/or compute multiple paths with the goals of, for example, improving network resource utilization and/or providing paths that may be a better match to a given network application's requirements, including the Label Distribution Protocol (“LDP”), the Resource Reservation Protocol (“RSVP”), and Segment Routing (“SR”). While these protocols may be an improvement over traditional single-path forwarding, they each may have some limitations.

An LDP operating model may be that of implementing label-swapped paths (“LSPs”) that may reflect those computing by the existing routing protocol. This may limit the multipath capabilities to multiple equal cost paths that may be already supported in existing routing protocols. This capability may be called equal cost multipath (“ECMP”). A benefit provided by LDP may be the aggregation of forwarding state into a smaller number of forwarding entries by the aggregation of large blocks of routes that may follow the same path using a single LSP.

In contrast, an RSVP operating model may be that of computing paths that may satisfy a given set of requirements. These requirements may be defined in terms of bandwidth, a single traffic-engineering metric, and an Administrative Group (or link color). RSVP may compute paths separately from the active routing protocol (e.g., Intermediate System to Intermediate System (“IS-IS”) or Open Shortest Path First (“OSPF”)), but may be based on the topology discovered by that protocol (e.g., augmented with the traffic engineering (“TE”) Metric (e.g., link metric for TE) and Administrative Group attributes). Given this enhanced topology, RSVP may run a separate Constrained Shortest Path First (“CSPF”) routing computation to find a path that may satisfy the additional constraints. It may then signal the network nodes along that path to install the MPLS state to implement the LSP, and then typically may monitor the underlying routing protocol (e.g., based on a configurable timer) to detect topology changes that may require updates to the LSP. RSVP may take advantage of the multipath capability of MPLS. However, due to delay and overhead for setting up and maintaining an RSVP-managed LSP, these paths may be typically setup on a semi-static basis for a small set of predictable network loads. RSVP may not be an efficient solution for ensuring all network flows use paths tailored to their needs.

Segment Routing has been developed (see, e.g., C. Filsfils, S. Previdi, L. Ginsberg, B. Decraene, S. Litkowski, R. Shakir, “Segment Routing Architecture,” RFC 8402, July 2018). In essence, SR may be a form of loose source routing where either an MPLS label stack or an SR Extension header, which may contain a list of IPv6 “segment” endpoints (e.g., similar to the IPv6 Routing Extension header), may be used to specify segments of a desired path. These paths may be computed using essentially the same CSPF routing algorithm that may be used in RSVP to find paths that meet traffic engineering constraints (see, e.g., Juniper Networks, “Enabling Distributed CSPF for Segment Routing LSPs”). Segment Routing may improve on LDP and RSVP in certain ways. Compared with LDP, SR may provide enhanced traffic engineering support and more general multipath routing. Compared with both LDP and RSVP, SR may be integrated with IS-IS and OSPF routing protocols (see, e.g., D. Singh, “Yet Another Blog About Segment Routing, Part3: SR-TE”), and SR may not require extensive network state (e.g., the segment routes may be carried in the packets), though scalability of carrying routes in the packets may impose limits in how far SR paths can diverge from shortest paths computed in the network. Lastly, compared with RSVP, SR may inherit the limited expressiveness of CSPF described above.

In contrast to LDP, RSVP, and SR, a communication model of this disclosure may provide a new routing model that may be based on the best set of paths between source and destination. In this model, routes may be pre-computed (e.g., computed on a topology-driven basis) that may provide the full range of performance and/or may support the full range of policies available in a network. At the detection of a new flow in the network, a forwarding computation may be performed that may select the path of those already computed for the given destination that may best satisfy the requirements of the new flow. State may then be added to the ingress network node that may implement the forwarding decision, and subsequent traffic may then be forwarded using the MPLS mechanism(s). That state may be removed when the end of the flow is detected (e.g., either by lack of activity or by any suitable protocol-specific mechanism).

As detailed in the Tables 3 and 4 below, a new communication model of this disclosure may have a number of benefits over others.

TABLE 3

| | How | How | TE | Multipath |
|---|---|---|---|---|
| Technology | built | updated | support | support |
| LDP/MPLS | Topology- | Slaved to | None | ECMP |
| | driven | routing | | |
| | | protocol | | |
| RSVP/MPLS | Manually | Timer-based | Traditional | ECMP |
| | | synchronization | (metric, | |
| | | with routing | Admin | |
| | | protocol | Group) | |
| Segment | Topology- | Integrated in | Enhanced | Satisfies |
| Routing | driven | routing | (performance | “dominant |
| | | protocol | & Boolean | set” of |
| | | | constraints) | performance |
| | | | | and Boolean |
| | | | | constraints |
| New Model | Topology- | Integrated in | Enhanced | Satisfies |
| | driven | routing | (performance | “dominant |
| | | protocol | & Boolean | set” of |
| | | | constraints) | performance |
| | | | | and Boolean |
| | | | | constraints |

TABLE 4

| Solution | Overhead | Routing Model | QoS | Admin. Policy |
|---|---|---|---|---|
| Overprovision | 2-3x needed | Best path | None | None |
| | capacity | | | |
| Diffserv | Overprovision, | Best path | Limited | None |
| | traffic | | support | |
| | classification, | | with PHBs | |
| | PHB in routers | | | |
| RSVP | Per-flow route | On-demand | CSPF | CSPF |
| | computation and | | bandwidth, | link |
| | path signaling, | | hop count, | color |
| | MPLS | | TE metric | |
| PBR/VRF | Per VRF routing | Multiple best | None | Packet |
| | process and | path VRFs | | header |
| | forwarding table, | | | fields |
| | route_map | | | (route_map) |
| | processing | | | |
| Segment | Per-flow route | On-demand | CSPF | CSPF |
| Routing | computation. | | bandwidth, | link |
| | SR route packet | | hop count, | color |
| | header space. | | TE metric | |
| New | Traffic | Best set | Network | Any visible or |
| Model | classification, | of paths | admin defined | otherwise |
| | routing | | performance | accessible |
| | complexity, | | metrics (or | true/false |
| | per traffic | | otherwise). | state |
| | class MPLS | | | |

In summary, this new communication routing model may provide various new features, including, but not limited to, a model that may combine benefits of LDP, RSVP, and SR (e.g., a model that may be topology-driven (e.g., like LDP, SR), a model that may support TE (e.g., like RSVP, SR), a model that may provide aggregation of forwarding state (e.g., like LDP, SR), a model that may have the ability to implement enhanced versions of ECMP (e.g., hop-by-hop may be done by LDP vs. only at ingress by RSVP, SR); a model that may be integrated with a routing mechanism, so lost coordination may not be possible (e.g., like SR), and/or the like), a model that may implement an enhanced version of TE based on finding the best set of paths given performance and Boolean constraints, and/or the like.

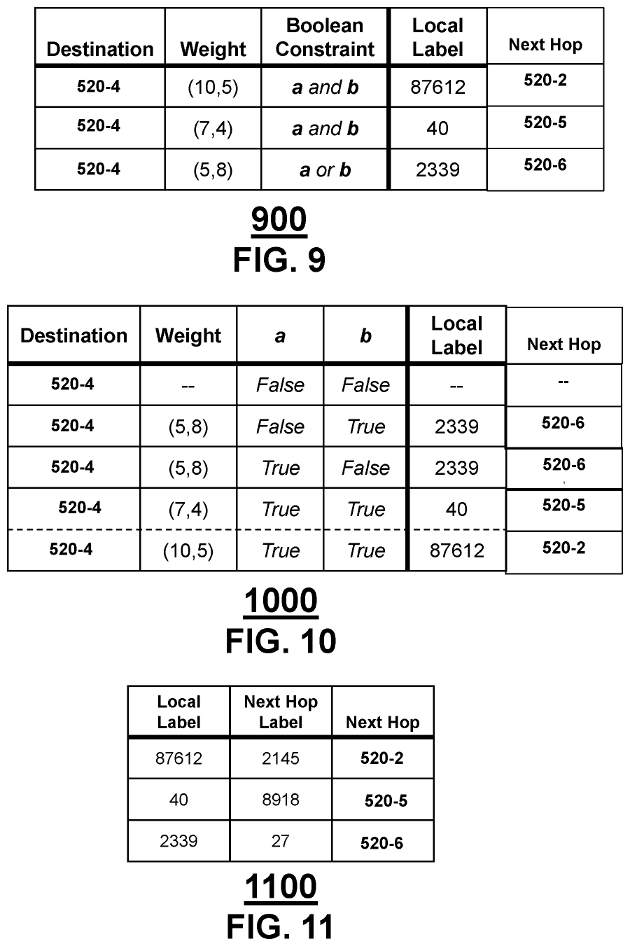

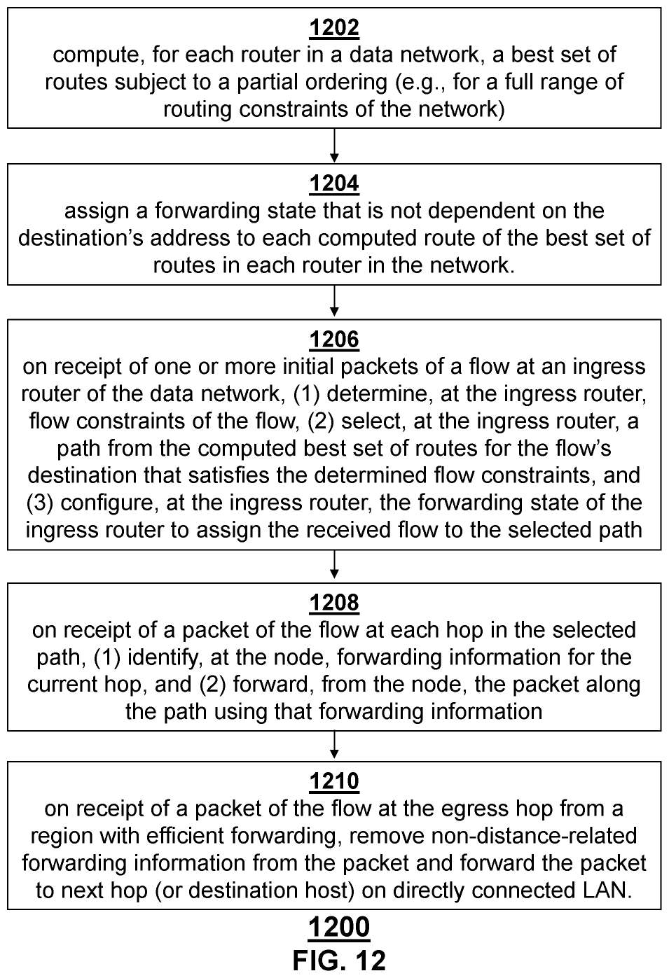

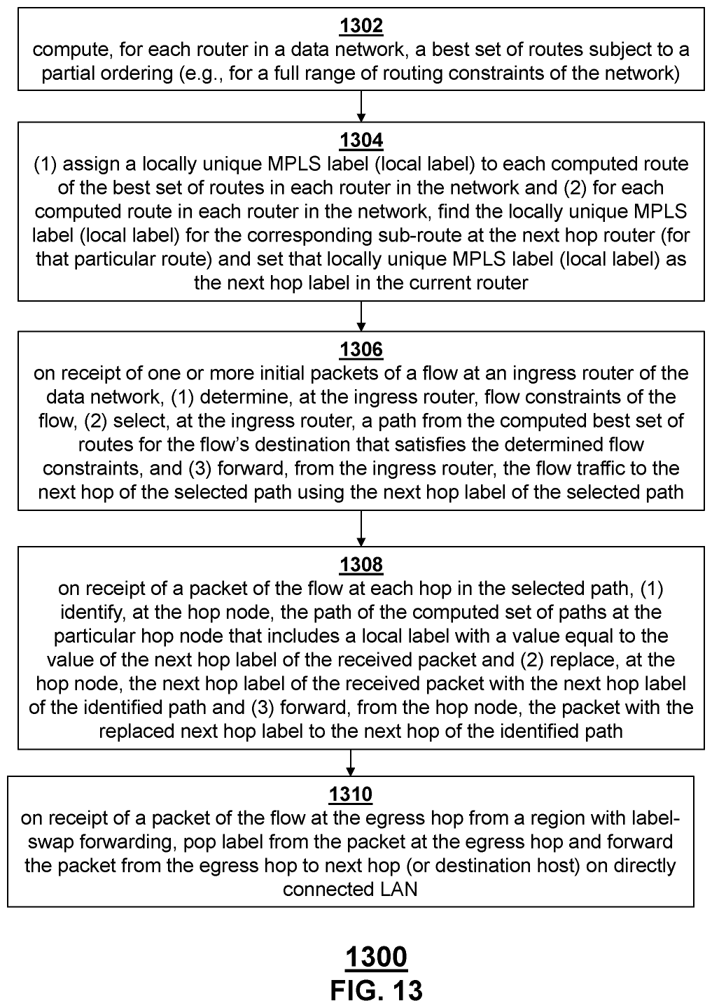

Referring back to network 500 of FIG. 5, given first path (1,2,3,4), second path (1,5,4), and third path (1,6,4) availability between node 520-1 and node 520-4, a combined DSMR and BCMR routing algorithm (e.g., Algorithm 2) may be configured to compute an improved data structure 900 of FIG. 9 that may be indicative of at least a portion of an improved routing table (e.g., routing table 314 of FIG. 3) of this new communication routing model for node 520-1, which may indicate a routing table entry row for each of the three paths from that node 520-1 to destination node 520-4 with weight constraint(s), Boolean constraint(s), a next hop, and a local label (e.g., a next hop may be determined in any suitable manner (e.g., as described with respect to operation 1202 of FIG. 12 and/or operation 1302 of FIG. 13) and a local label may be determined in any suitable manner (e.g., as described with respect to operation 1204 of FIG. 12 and/or operation 1304 of FIG. 13)). A data structure 1000 of FIG. 10 may be indicative of at least a portion of an improved conceptual routing table of this new communication routing model, where the truth assignments to Boolean variables in the Boolean constraints of the different paths may be provided (e.g., data structure 1000 may show, for each of the possible truth assignments of the Boolean variable values for the Boolean variables a and b, the different route(s) that may be available between node 520-1 and node 520-4 (e.g., with weight constraint(s) and local label and next hop)). It should be noted that while there are rows in data structure 1000 for next hops 520-5 and 520-2 when the truth assignments are True True, there is no row in data structure 1000 for next hop 520-6 when the truth assignments are True True because the bandwidth/delay weight constraint (5,8) for next hop 520-6 is dominated by the bandwidth/delay weight constraint (7,4) for next hop 520-5 and the bandwidth/delay weight constraint (10,5) for next hop 520-2. A data structure 1100 of FIG. 11 may be indicative of at least a portion of an improved destination independent multipath forwarding table of this new communication routing model for node 520-1, which may indicate a forwarding table entry row for each unique local label in the routing table that row may include that associated local label (e.g., as provided by the routing table of FIG. 9 and/or of FIG. 10) along with an associated next hop label (e.g., a next hop label may be determined in any suitable manner (e.g., as described with respect to operation 1206 of FIG. 12 and/or operation 1306 of FIG. 13)) and data indicative of the next hop (e.g., node identifier). A forwarding table of a node may be a byproduct of a much larger routing table of the node (e.g., a routing table may have more fields than the forwarding table (e.g., constraints, destination, etc.), but both tables may have the same number of rows). For example, every row of a routing table may be associated with a unique local label, where a local label may be a unique path identifier for the node the routing table is local to, while every row of a forwarding table may be associated with such a respective unique local label, while a forwarding table may include two or more rows with the same next hop label. While a local label and a next hop for a particular remote node in such routing and forwarding tables at a current node may describe a path between those nodes, such that the number of rows in a routing table and in the forwarding table at a node may be the same, the number of fields in a forwarding table may be drastically reduced from the number of fields in a routing table at a particular node, as the forwarding table may only include local label and next hop label and next hop identifier fields, whereas the routing table may include more fields (e.g., constraint(s), destination, etc.). A forwarding table may be constructed for a router before a particular flow of packets is received at the router (e.g., up front forward table construction), or a forwarding table may be at least partially constructed in response to a particular flow of packets being received (e.g., on demand forward table construction).

FIG. 12 is a flowchart of an illustrative process 1200 for packet routing according to a new routing model, where packets may be forwarded over different paths of a best set of paths using forwarding state that may not be based on destination address information (e.g., efficient forwarding over best set of paths). At operation 1202, any suitable component(s) or equipment of or associated with a data network may compute, for each router in the data network, a best set of routes or paths (e.g., between each source/destination node pair) subject to a partial ordering, such as for a full range of routing constraints of the network (e.g., routing constraints 315 may be used to compute a routing table 314 (e.g., a routing table of FIG. 9) for each router device of the network). At operation 1204, any suitable component(s) or equipment of or associated with a data network may assign forwarding state that is not dependent on the destination's address to each computed route of the best set of routes in each router in the network (e.g., a forwarding table 322 (e.g., a destination independent forwarding table of FIG. 11) may be assigned or otherwise provided for each router device of the network). At operation 1206, any suitable component(s) or equipment of or associated with a particular router of the network, on receipt of one or more initial packets of a flow at the particular router as an ingress router of the network (e.g., packet(s) 303 at router 320), may (1) determine, at the ingress router, flow constraints of the flow (e.g., from configured information (e.g., flow constraints 316 (e.g., and current values thereof))), which may include collecting data from any suitable remote source(s) (e.g., any suitable data 99 from any suitable data device 118), (2) select, at the ingress router, a path from the computed best set of routes for the flow's destination that satisfies the determined flow constraints (e.g., path selection 306 using a routing table 314 of the router (e.g., a routing table computed at operation 1202) and any suitable flow constraints 316 (e.g., to identify a local label 305 for the flow at that router)), and (3) configure, at the ingress router, the forwarding state of the ingress router to assign the received flow to the selected path (e.g., to assign the identified local label 305 of the routing table to the flow at that router). At operation 1208, any suitable component(s) or equipment of or associated with a particular router of the network, on receipt of a packet of the flow at each hop node of the selected path (e.g., a packet with forwarding information or local label 305 (e.g., as may have been assigned at operation 1206/306 by the source node) as received at the source node of the selected path (e.g., at operation 308 after operation 306) or a packet with forwarding information or next hop label 307 as received at any intermediate hop node of the selected path (e.g., at operation 308 after operation 304 rather than after operation 306) may (1) identify, at the node, any suitable forwarding information (or forwarding identifier or next hop label) of the received packet (e.g., identify an associated next hop label 307 and next hop node using local label 305 with packet 303 at operation 308 for the current hop (e.g., in conjunction with a forwarding table for the node (e.g., a forwarding table (e.g., forwarding table 322) computed at operation 1204))), and (2) forward, from the node to the next hop node of the identified next hop node, the packet along the path using that forwarding information (e.g., destination independent forwarding 308 swapping in the identified next hop label 307 for the local label 305)). At operation 1210, any suitable component(s) or equipment of or associated with a particular router of the network, on receipt of a packet of the flow at the particular router as the egress hop router from a region with efficient forwarding, may remove non-distance-related forwarding information from the packet and forward it to the next hop (or destination host) on a directly connected LAN. As just one example, when a routing table of FIG. 9 and a forwarding table of FIG. 11 may be computed by process 1200 and a flow is received at source node 520-1 for routing to destination node 520-4, where flow constraints of the flow are indicative of Boolean values True, True for Boolean variables a,b such that the paths of the 4^{th} and 5^{th} rows of the table of FIG. 10 (e.g., the 2^{nd} and 1^{st} rows of the table of FIG. 9) may be identified as satisfying paths for the flow with respect to the Boolean constraints, the weight constraint (7,4) of the path of the 4^{th} row and the weight constraint (10,5) of the path of the 5^{th} row may be analyzed with any other suitable available data to select one of those two paths for use (e.g., at operation 1206). One of multiple allowable paths may be chosen based on a local load-balancing algorithm or the like. Therefore, “best set of paths” routing may be paired with non-destination based forwarding technologies (e.g., MPLS, Segment Routing, Source Routing, etc.). Therefore, labels may be determined by best set of paths (e.g., taking into account all constraints of the links). However, once one of those Boolean constraint satisfying paths may be selected for the flow, then the ingress router (e.g., node 520-1) may configure the forwarding state of the router for that flow to assign the flow to the selected path (e.g., use the next hop or local label of that selected path (e.g., of the routing table) to identify the associated next hop label (e.g., of the forwarding table) in order to communicate the packet with the identified next hop label from the ingress router to the next hop).

Therefore, a new routing model may be provided that may be based on a best set of routes between source and destination, where routes may be pre-computed (e.g., computed on a topology-driven basis (e.g., at operation 1202)) that may provide the full range of performance and/or may support the full range of policies available in a network, while a forwarding state that is not dependent on the destination may be assigned to each computed route (e.g., at operation 1204 (e.g., the forwarding table (e.g., as configured at the router per flow) need not identify a destination node of the entire path)). At the detection of a new flow in the network, a forwarding computation may be performed that may select the path of those already computed for the given destination that may best satisfy the requirements of the new flow and a new state may then be added to the ingress network node that may implement the forwarding decision (e.g., at operation 1206), and subsequent traffic for that flow may then be forwarded using that new state via any suitable mechanisms, such as MPLS mechanism(s), segment routing mechanism(s), source routing mechanism(s), and/or the like (e.g., at operation 1208). That state may be removed when the end of the flow is detected (e.g., either by lack of activity or by any suitable protocol-specific mechanism).

The operations shown in process 1200 of FIG. 12 are only illustrative and that existing operations may be modified or omitted, additional operations may be added, and the order of certain operations may be altered.

FIG. 13 is a flowchart of an illustrative process 1300 for packet routing according to a new routing model, where packets may be forwarded over different paths of a best set of paths (e.g., efficient forwarding traffic over different paths of a best set of paths using label-swap forwarding state (e.g., label switching (e.g., MPLS))). At operation 1302, any suitable component(s) or equipment of or associated with a data network may compute, for each router in the data network, a best set of routes or paths (e.g., between each source/destination node pair) subject to a partial ordering, such as for a full range of routing constraints of the network (e.g., routing constraints 315 may be used to compute a routing table 314 (e.g., a routing table of FIG. 9 or of FIG. 14) for each router device of the network). At operation 1304, any suitable component(s) or equipment of or associated with a data network may (1) assign a locally unique MPLS label (local label) to each computed route of the best set of routes in a routing table at each router in the network (e.g., a routing table 314 (e.g., a routing table of FIG. 9 or of FIG. 14) for each router device of the network)) and, (2) for each computed route in each router in the network, find the locally unique MPLS label (local label) for the corresponding sub-route at the next hop router (for that particular route) and set that locally unique MPLS label (local label) of the next hop router as the next hop label in the current router, such as in a forwarding table at each router in the network (e.g., a forwarding table 322 (e.g., a destination independent forwarding table of FIG. 11 or of FIG. 14)). At operation 1306, any suitable component(s) or equipment of or associated with a particular router of the network, on receipt of one or more initial packets of a flow at the particular router as an ingress router of the network (e.g., packet(s) 303 at router 320), may (1) determine, at the ingress router, flow constraints of the flow (e.g., from configured information (e.g., flow constraints 316 (e.g., and current values thereof))), which may include collecting data from any suitable remote source(s) (e.g., any suitable data 99 from any suitable data device 118), (2) select, at the ingress router, a path from the computed best set of routes for the flow's destination that satisfies the determined flow constraints (e.g., path selection 306 using a routing table 314 of the router (e.g., a routing table computed at operation 1202) and any suitable flow constraints 316 (e.g., to identify a local label 305 for the flow at that router)), and (3) forward, from the ingress router, the flow traffic to the next hop of the selected path using the next hop label of the selected path (e.g., the next hop label of the selected path's row of the forwarding table of the ingress router may be forwarded along with any packets of the flow to the next hop of the selected path's row of the forwarding table of the ingress router). At operation 1308, any suitable component(s) or equipment of or associated with a particular router of the network, on receipt of a packet of the flow at each hop node of the selected path (e.g., a packet with the next hop label of the forwarding table of the node that forwarded the packet to this particular hop node (e.g., the label assigned at the previous router prior to this hop router)), may (1) identify, at the hop node, the path of the computed set of paths at the particular hop node that includes a local label with a value equal to the value of the next hop label of the received packet and (2) replace, at the hop node, the next hop label of the received packet with the next hop label of the identified path and (3) forward, from the hop node, the packet with the replaced next hop label to the next hop of the identified path. At operation 1310, any suitable component(s) or equipment of or associated with a particular router of the network, on receipt of a packet of the flow at the particular router as the egress hop router from a region with label-swap forwarding, may pop (e.g., remove, strip, etc.) the next hop label from the packet at the egress hop and forward the packet from the egress hop to the next hop (or destination host) on a directly connected LAN.

Therefore, a new routing model may be provided that may be based on a best set of routes between source and destination, where routes may be pre-computed (e.g., computed on a topology-driven basis (e.g., at operation 1302)) that may provide the full range of performance and/or may support the full range of policies available in a network, while a forwarding state that is not dependent on the destination may be assigned to each computed route (e.g., at operation 1304 (e.g., the forwarding table (e.g., as configured at the router per flow) need not identify a destination node of the entire path)). At the detection of a new flow in the network, a forwarding computation may be performed that may select the path of those already computed for the given destination that may best satisfy the requirements of the new flow and state may then be added to the ingress network node that may implement the forwarding decision (e.g., at operation 1306), and subsequent traffic may then be forwarded using any suitable mechanisms, such as MPLS mechanism(s) (e.g., next hop labels), and/or the like (e.g., at operation 1308). That state may be removed when the end of the flow is detected (e.g., either by lack of activity or by any suitable protocol-specific mechanism).

The operations shown in process 1300 of FIG. 13 are only illustrative and that existing operations may be modified or omitted, additional operations may be added, and the order of certain operations may be altered.

FIG. 14 shows at least a portion of a network 1400 that may include any suitable number of nodes or router devices 1420 (e.g., node 1420-W, node 1420-X, node 1420-Y, and node 1420-Z), where different nodes may be communicatively coupled to one another (e.g., using communication components of the nodes) over different communication links 1425 (e.g., link 1425-X.Z between nodes 1420-X and 1420-Z, link 1425-W.X between nodes 1420-W and 1420-X, link 1425-W.Y between nodes 1420-W and 1420-Y, and link 1425-Y.Z between nodes 1420-Y and 1420-Z), and where each link may be associated with specific example constraints (e.g., performance constraints and/or policy constraints and/or service chaining constraints, etc.). For example, as shown, certain constraints of a link may be provided with at least one Boolean constraint (e.g., as a policy constraint, etc.) that may be defined by any suitable Boolean expression that may be composed of any suitable Boolean variable(s) (e.g., Boolean variable “A” and Boolean variable “B”, although any additional or alternative Boolean variable(s) and/or Boolean constraints may be associated with one, some, or each link), which may be used to express a constraint of flows using the network. As just some specific examples of constraints with a “Boolean expression (A, B)” Boolean constraint, link 1425-X.Z may include a Boolean constraint with a Boolean expression [A and notB], link 1425-W.X may include a Boolean constraint with a Boolean expression [A or B], link 1425-W.Y may include a Boolean constraint with a Boolean expression [A or B], and link 1425-Y.Z may include a Boolean constraint with a Boolean expression [notA and B]. In this portion of network 1400, hops between two particular nodes 1420 may vary amongst different paths of one or more links 1425, and each link may or may not satisfy a particular Boolean test. Routing based on just one Boolean test per device may not be suitable for all application types.

As shown in FIG. 14, various paths may exist between nodes 1420-Z and 1420-W, including a first path (Z,X,W) that may include links 1425-X.Z and 1425-W.X, and a second path (Z,Y,W) that may include links 1425-Y.Z and 1425-W.Y. Any suitable algorithm(s) may be configured to compute any suitable data structure(s) 1490 for one, some, or each router in the network in any suitable fashion(s) and/or in accordance with any suitable protocol(s) (e.g., centrally, distributed, locally, etc.). For example, as shown in FIG. 14, a data structure 1490-W may be computed for router 1420-W, a data structure 1490-X may be computed for router 1420-X, a data structure 1490-Y may be computed for router 1420-Y, and a data structure 1490-Z may be computed for router 1420-Z, where each one of such structures 1490 may be illustrated as a combination of a routing table and a forwarding state (e.g., local swap) table, which may be referred to herein as a merged communication table. As shown, the data structure of each particular node's merged communication table may include one or more rows of data, where the data of each row may be associated with a particular path between the particular node and a destination node. For example, the data of each row may be associated with a particular route of the best set of routes (e.g., as may be computed at operation 1202 and/or operation 1302), where the data of a first column (“Destination Address” column) of the merged communication table of each particular node may be indicative of a destination address or destination node for each computed path between the particular node and that destination node (e.g., for each merged table row) (e.g., as may be computed at operation 1202 and/or operation 1302), where the data of a fourth column (“Next Hop” column) of the merged communication table of each particular node may be indicative of a next hop address or next hop node that follows the particular node along each computed path between the particular node and a destination node (e.g., of each merged table row) (e.g., as may be computed at operation 1202 and/or operation 1302), where the data of a second column (“Constraint(s)” column) of the merged communication table of each particular node may be indicative of one, some, or each constraint associated with each link extending between the particular node and a next hop node (e.g., of each merged table row) (e.g., as may be computed at operation 1202 and/or operation 1302), where the data of a third column (“Local Label”) of the merged communication table of each particular node may be indicative of a label that may be locally unique to the particular node for a particular computed path (e.g., of a merged table row) (e.g., as may be computed at operation 1204 and/or operation 1304), and where the data of a fifth column (“Next Hop Label”) of the merged communication table of each particular node may be indicative of a label that may be provided by the next hop node that follows the particular node along each computed path between the particular node and a destination node (e.g., of each merged table row) (e.g., as may be computed at operation 1204 and/or operation 1304).

As one particular example, when operation 1302 of process 1300 may compute at least one route of a best set of routes from source node 1420-Z to destination node 1420-W, at least the first route (Z,X,W) including links 1425-X.Z and 1425-W.X may be identified, in which case operation 1302 may populate the merged communication tables of nodes 1420-W, 1420-X, and 1420-Z of first route (Z,X,W) as follows: (1) a first row 1402 of data structure 1490-Z of node 1420-Z associated with first route (Z,X,W) may have (1a) its portion of the Destination Address column populated by data indicative of destination node W of first route (Z,X,W), (1b) its portion of the Next Hop column populated by data indicative of next hop node X of first route (Z,X,W), and (1c) its portion of the Constraint(s) column populated by data indicative of any or all constraints associated with link 1425-X.Z extending between particular node Z and next hop node X of first route (Z,X,W) (e.g., Boolean constraint expression “A and notB”); (2) a first row 1430 of data structure 1490-X of node 1420-X associated with first route (Z,X,W) may have (2a) its portion of the Destination Address column populated by data indicative of destination node W of first route (Z,X,W), (2b) its portion of the Next Hop column populated by data indicative of next hop node W of first route (Z,X,W), and (2c) its portion of the Constraint(s) column populated by data indicative of any or all constraints associated with link 1425-W.X extending between particular node X and next hop node W of first route (Z,X,W) (e.g., Boolean constraint expression “A or B”); and (3) a first row 1440 of data structure 1490-W of node 1420-W associated with first route (Z,X,W) may have (3a) its portion of the Destination Address column populated by data indicative of destination node W of first route (Z,X,W), (3b) its portion of the Next Hop column populated by data indicative of null data (e.g., as there is no next hop node after destination node W of first route (Z,X,W)), and (3c) its portion of the Constraint(s) column populated by data indicative of null data (e.g., as there may be no link extending between particular node W and a non-existent next hop node of first route (Z,X,W)). Then, continuing with this example, a first portion of operation 1304 of process 1300 may continue to populate the merged communication table of nodes 1420-W, 1420-X, and 1420-Z of first route (Z,X,W) as follows: (1) first row 1402 of data structure 1490-Z of node 1420-Z associated with first route (Z,X,W) may have its portion of the Local Label column populated by data indicative of a label that may be locally unique to particular node 1420-Z (e.g., “1” as shown in FIG. 14, but may be any suitable unique random number that may be robust enough to be unique to the particular router node (e.g., to data structure 1490-Z)); (2) first row 1430 of data structure 1490-X of node 1420-X associated with first route (Z,X,W) may have its portion of the Local Label column populated by data indicative of a label that may be locally unique to particular node 1420-X (e.g., “6” as shown in FIG. 14, but may be any suitable unique random number that may be robust enough to be unique to the particular router node (e.g., to data structure 1490-X)); and (3) first row 1440 of data structure 1490-W of node 1420-W associated with first route (Z,X,W) may have its portion of the Local Label column populated by data indicative of a label that may be locally unique to particular node 1420-W (e.g., “1” as shown in FIG. 14, but may be any suitable unique random number that may be robust enough to be unique to the particular router node (e.g., to data structure 1490-W)). Each local label and each next hop label may be significantly longer than the labels shown in FIG. 14 (see, e.g., the labels of FIGS. 9-11). Then, continuing further with this example, a second portion of operation 1304 of process 1300 may continue to populate the merged communication table of nodes 1420-W, 1420-X, and 1420-Z of first route (Z,X,W) as follows: (1) first row 1402 of data structure 1490-Z of node 1420-Z associated with first route (Z,X,W) may have its portion of the Next Hop Label column populated by data indicative of a label that may be locally unique to next hop node X from particular node Z of first route (Z,X,W) and that may be associated with first route (Z,X,W) at that next hop node X (e.g., “6” as shown in FIG. 14, which is the local label of first row 1430 of data structure 1490-X of next hop node 1420-X associated with first route (Z,X,W) (e.g., as may have been defined in the first portion of operation 1304)); (2) first row 1430 of data structure 1490-X of node 1420-X associated with first route (Z,X,W) may have its portion of the Next Hop Label column populated by data indicative of a label that may be locally unique to next hop node W from particular node X of first route (Z,X,W) and that may be associated with first route (Z,X,W) at that next hop node W (e.g., “1” as shown in FIG. 14, which is the local label of first row 1440 of data structure 1490-W of next hop node 1420-W associated with first route (Z,X,W) (e.g., as may have been defined in the first portion of operation 1304)); and (3) first row 1440 of data structure 1490-W of node 1420-W associated with first route (Z,X,W) may have its portion of the Next Hop Label column populated by data indicative of null data (e.g., as there is no next hop node after destination node W of first route (Z,X,W)). The next hop label data may be populated using any suitable technique(s), including LDP (e.g., a node may request from its neighbors), centralize, and/or the like.

As one other particular example, when operation 1302 of process 1300 may compute at least one other route of a best set of routes from source node 1420-Z to destination node 1420-W, at least the second route (Z,Y,W) including links 1425-Y.Z and 1425-W.Y may be identified, in which case operation 1302 may (further) populate the merged communication tables of nodes 1420-W, 1420-X, and 1420-Z of second route (Z,Y,W) as follows: (1) a second row 1410 of data structure 1490-Z of node 1420-Z associated with second route (Z,Y,W) may have (1a) its portion of the Destination Address column populated by data indicative of destination node W of second route (Z,Y,W), (1b) its portion of the Next Hop column populated by data indicative of next hop node Y of second route (Z,Y,W), and (1c) its portion of the Constraint(s) column populated by data indicative of any or all constraints associated with link 1425-Y.Z extending between particular node Z and next hop node Y of second route (Z,Y,W) (e.g., Boolean constraint expression “notA and B”); and (2) a first row 1450 of data structure 1490-Y of node 1420-Y associated with second route (Z,Y,W) may have (2a) its portion of the Destination Address column populated by data indicative of destination node W of second route (Z,Y,W), (2b) its portion of the Next Hop column populated by data indicative of next hop node W of second route (Z,Y,W), and (2c) its portion of the Constraint(s) column populated by data indicative of any or all constraints associated with link 1425-W.Y extending between particular node Y and next hop node W of second route (Z,Y,W) (e.g., Boolean constraint expression “A or B”), while it may be determined that a new row of data need not be added to data structure 1490-W of node 1420-W beyond row 1440 as that row may already be associated with second route (Z,Y,W) and may have its portion of the Destination Address column populated by data indicative of destination node W of second route (Z,Y,W), its portion of the Next Hop column populated by data indicative of null data (e.g., as there is no next hop node after destination node W of second route (Z,Y,W)), and its portion of the Constraint(s) column populated by data indicative of null data (e.g., as there may be no link extending between particular node W and a non-existent next hop node of second route (Z,Y,W)). Then, continuing with this example, a first portion of operation 1304 of process 1300 may continue to populate the merged communication table of nodes 1420-W, 1420-X, and 1420-Z of second route (Z,Y,W) as follows: (1) second row 1410 of data structure 1490-Z of node 1420-Z associated with second route (Z,Y,W) may have its portion of the Local Label column populated by data indicative of a label that may be locally unique to particular node 1420-Z (e.g., “2” as shown in FIG. 14, but may be any suitable unique random number that may be robust enough to be unique to the particular router node (e.g., to data structure 1490-Z)); and (2) first row 1450 of data structure 1490-Y of node 1420-Y associated with second route (Z,Y,W) may have its portion of the Local Label column populated by data indicative of a label that may be locally unique to particular node 1420-Y (e.g., “9” as shown in FIG. 14, but may be any suitable unique random number that may be robust enough to be unique to the particular router node (e.g., to data structure 1490-Y)); while first row 1440 of data structure 1490-W of node 1420-W may be associated with second route (Z,Y,W) as its portion of the Local Label column may already be populated by data indicative of a label that may be locally unique to particular node 1420-W (e.g., “1” as shown in FIG. 14, but may be any suitable unique random number that may be robust enough to be unique to the particular router node (e.g., to data structure 1490-W) for any path with a destination of node W). Then, continuing further with this example, a second portion of operation 1304 of process 1300 may continue to populate the merged communication table of nodes 1420-W, 1420-X, and 1420-Z of second route (Z,Y,W) as follows: (1) second row 1410 of data structure 1490-Z of node 1420-Z associated with second route (Z,Y,W) may have its portion of the Next Hop Label column populated by data indicative of a label that may be locally unique to next hop node Y from particular node Z of second route (Z,Y,W) and that may be associated with second route (Z,Y,W) at that next hop node Y (e.g., “9” as shown in FIG. 14, which is the local label of first row 1450 of data structure 1490-Y of next hop node 1420-Y associated with second route (Z,Y,W) (e.g., as may have been defined in the first portion of operation 1304)); and (2) first row 1450 of data structure 1490-Y of node 1420-Y associated with second route (Z,Y,W) may have its portion of the Next Hop Label column populated by data indicative of a label that may be locally unique to next hop node W for any route for which node W is the destination (e.g., second route (Z,Y,W)) and that may be associated with second route (Z,Y,W) at that next hop node W (e.g., “1” as shown in FIG. 14, which is the local label of first row 1440 of data structure 1490-W of next hop node 1420-W associated with second route (Z,Y,W) (e.g., as may have been defined in the first portion of operation 1304)), while first row 1440 of data structure 1490-W of node 1420-W associated with second route (Z,Y,W) may have its portion of the Next Hop Label column populated by data indicative of null data (e.g., as there is no next hop node after destination node W of second route (Z,Y,W)).

Once data structures 1490 have been populated for defining a merged communication table for various nodes of a network (e.g., at operations 1302 and 1304 of process 1300), one or more initial packets of a flow (e.g., packets without an assigned path (e.g., without any forwarding label(s)) may be received at a particular router as an ingress router of the network for that flow (e.g., packet(s) 303 at router 320), and operation 1306 may (1) determine, at the ingress router (e.g., node 1420-Z or router 320), flow constraints of the flow (e.g., flow constraints 316), which may include collecting data from any suitable remote source(s) (e.g., any suitable data 99 from any suitable data device 118)), (2) select, at the ingress router (e.g., node 1420-Z or router 320), a path from the computed best set of routes for the flow's destination that satisfies the determined flow constraints (e.g., path selection 306/1306 using a routing table of the router (e.g., routing table 314 of router 320 computed at routing process 312 and/or a routing table portion of data structure 1490-Z of node 1420-Z computed at operation 1302) and any suitable flow constraints 316, which may identify a local label for the flow at that router (e.g., local label 305 for providing packet 303″ (e.g., packet 303 with local label 305)). For example, if the flow received at source node 1420-Z is indicative of data to be communicated from source node 1420-Z to destination node 1420-W and current Boolean constraint variable values are determined to be A=True and B=False (e.g., by analyzing any determined flow constraints of the flow in light of the routing table of data structure 1490-Z of node Z), then it may be determined that only first route (Z,X,W) of the routing table satisfies the determined flow constraints (e.g., the constraint “A and notB” of first row 1402 of data structure 1490-Z for destination W is satisfied when A=True and B=False) but that second route (Z,Y,W) of the routing table does not satisfy the determined flow constraints (e.g., the constraint “notA and B” of second row 1410 of data structure 1490-Z for destination W is not satisfied when A=True and B=False), and that first route (Z,X,W) may be selected (e.g., at path selection 306 and/or operation 1306) such that the local label “1” of the routing table for that selected path may be chosen and used to configure the forwarding state of node 1420-Z for the flow (e.g., that local label may be passed as local label 305 with packet 303 as packet 303″ from path selection 306 to destination independent forwarding 308). Next, that selected local label may be used to carry out destination independent forwarding of the packet to a next hop in the selected path (e.g., destination independent forwarding 308 may receive packet 303″ and use local label 305 of the node to identify a next hop label for the next hop node in the path (e.g., using forwarding table 322 of router 320 computed at routing process 312 and/or a forwarding table portion of data structure 1490-Z of node 1420-Z computed at operation 1304)). For example, node 1490-Z may utilize local label “1” to identify next hop label “6” in the forwarding table of node 1490-Z and may swap local label “1” out for next hop label “6” for communication with packet 303 to the next hop (e.g., destination independent forwarding 308 may receive packet 303″ with local label 305 of value “1” and swap it out with next hop label 309 of value “6” for defining packet 303′″ (e.g., packet 303 with next hop label “6”), which may be forwarded on from node 1420-Z to next hop node 1420-X (e.g., after negative determinations at operations 310 and 319 with respect to the packet)).

Continuing with this example, node 1420-X may receive such a packet 303′″ (e.g., packet 303′ with next hop label “6”) as incoming data and may identify, at node 1420-X, the path of the computed set of paths at the particular hop node that includes a local label with a value equal to the value of the next hop label of the received packet and (2) replace, at the hop node, the next hop label of the received packet with the next hop label of the identified path and (3) forward, from the hop node, the packet with the replaced next hop label to the next hop of the identified path (e.g., at operation 1308). For example, as shown in FIG. 3, a packet with a next hop label, identified as packet 303′ (a packet with next hop label 307), may be received at a router node 320 and operation 304 may determine that the received packet 303′ may include an assigned path (e.g., the received data includes a hop label (e.g., label 307)) and then will provide that received packet 303′ to destination independent forwarding 308, which may use the label 307 of the received packet 303′ to identify a new label (e.g., new next hop label 309) and destination for the packet using the forwarding table of the router. For example, at operation 1406, when node 1420-X may receive a packet with next hop label “6” (e.g., as described above from node 1420-Z), node 1420-X may use the forwarding table portion of data structure 1490-X to identify the path (e.g., row of the forwarding table) that includes a local label with a value equal to the value of the next hop label “6” of the received packet (e.g., to identify row 1430 of the forwarding table portion of data structure 1490-X as including a local label “6” that matches the value of next hop label “6” of the received packet), and then node 1420-X may replace the next hop label of the received packet with the next hop label of the identified path (e.g., replace next hop label “6” of the received packet with next hop label “1” of the identified row 1430 (e.g., at operation 308 by replacing label 307 with label 309)), and then node 1420-X may forward the packet with the replaced next hop label to the next hop of the identified path (e.g., forward the received packet, but now with next hop label “1” rather than next hop label “6”, to next hop node 1420-W of the identified row 1430 (e.g., by forwarding packet 303′″ with the replaced next hop label 309 to the next hop)).

Continuing with this example, node 1420-W may receive such a packet 303′″ (e.g., packet 303′ with next hop label “1”) as incoming data and may identify, at node 1420-W, the path of the computed set of paths at the particular hop node that includes a local label with a value equal to the value of the next hop label of the received packet and (2) determine that the particular hop node is the destination node of the identified path (e.g., that node 1420-W is the egress hop of the identified path of the received packet) and (3) pop the next hop label from the received packet at the egress hop and forward the packet from the egress hop to next hop (or destination host) on directly connected LAN (e.g., at operation 1310). For example, as shown in FIG. 3, a packet with a next hop label, identified as packet 303′ (a packet with next hop label 307), may be received at a router node 320 and operation 304 may determine that the received packet 303′ may include an assigned path (e.g., the received data includes a hop label (e.g., label 307)) and then will provide that received packet 303′ to destination independent forwarding 308, which may use the label 307 of the received packet 303′ to identify that router node 320 is the egress hop for the received packet using the forwarding table of the router and then pop out the label (e.g., pop out label 307 at operation 317 or operation 321) and provide as a packet 303″″ with no next hop label to a next hop (or destination host) on directly connected LAN (e.g., dependent upon determinations at operation 310 and/or operation 319). For example, at operation 1410, when node 1420-W may receive a packet with next hop label “1” (e.g., as described above from node 1420-X), node 1420-W may use the forwarding table portion of data structure 1490-W to identify the path (e.g., row of the forwarding table) that includes a local label with a value equal to the value of the next hop label “1” of the received packet (e.g., to identify row 1440 of the forwarding table portion of data structure 1490-W as including a local label “1” that matches the value of next hop label “1” of the received packet), and then node 1420-W may determine that there is no next hop label identified by the forwarding table portion of data structure 1490-W for the identified path, such that node 1420-W may determine that it is the egress router for the packet's flow and then pop (e.g., remove) the next hop label “1” from the received packet and then handle the packet accordingly (e.g., forward the packet from the egress hop to a next hop (or destination host) on directly connected LAN (e.g., at operation 1310)).

As another example, once data structures 1490 have been populated for defining a merged communication table for various nodes of a network (e.g., at operations 1302 and 1304 of process 1300), a flow may be received at source node 1420-Z that is indicative of data to be communicated from source node 1420-Z to destination node 1420-W and current Boolean constraint variable values are determined to be A=False and B=True (e.g., by analyzing any determined flow constraints of the flow in light of the routing table of data structure 1490-Z of node Z), and then it may be determined that only second route (Z,Y,W) of the routing table satisfies the determined flow constraints (e.g., the constraint “notA and B” of second row 1410 of data structure 1490-Z for destination W is satisfied when A=False and B=True) but that first route (Z,X,W) of the routing table does not satisfy the determined flow constraints (e.g., the constraint “A and notB” of first row 1402 of data structure 1490-Z for destination W is not satisfied when A=False and B=True), and that second route (Z,Y,W) may be selected (e.g., at path selection 306 and/or operation 1306) such that the local label “2” of the routing table for that selected path may be chosen and used to configure the forwarding state of node 1420-Z for the flow (e.g., that local label may be passed as local label 305 with packet 303 as packet 303″ from path selection 306 to destination independent forwarding 308). Next, that selected local label may be used to carry out destination independent forwarding of the packet to a next hop in the selected path (e.g., destination independent forwarding 308 may receive packet 303″ and use local label 305 of the node to identify a next hop label for the next hop node in the path (e.g., using forwarding table 322 of router 320 computed at routing process 312 and/or a forwarding table portion of data structure 1490-Z of node 1420-Z computed at operation 1304)). For example, node 1490-Z may utilize local label “2” to identify next hop label “9” in the forwarding table of node 1490-Z and may swap local label “2” out for next hop label “9” for communication with packet 303 to the next hop (e.g., destination independent forwarding 308 may receive packet 303″ with local label 305 of value “2” and swap it out with next hop label 309 of value “9” for defining packet 303′″ (e.g., packet 303 with next hop label “9”), which may be forwarded on from node 1420-Z to next hop node 1420-Y (e.g., after negative determinations at operations 310 and 319 with respect to the packet)).

Continuing with this example, node 1420-Y may receive such a packet 303′″ (e.g., packet 303′ with next hop label “9”) as incoming data and may identify, at node 1420-Y, the path of the computed set of paths at the particular hop node that includes a local label with a value equal to the value of the next hop label of the received packet and (2) replace, at the hop node, the next hop label of the received packet with the next hop label of the identified path and (3) forward, from the hop node, the packet with the replaced next hop label to the next hop of the identified path (e.g., at operation 1308). For example, as shown in FIG. 3, a packet with a next hop label, identified as packet 303′ (a packet with next hop label 307), may be received at a router node 320 and operation 304 may determine that the received packet 303′ may include an assigned path (e.g., the received data includes a hop label (e.g., label 307)) and then will provide that received packet 303′ to destination independent forwarding 308, which may use the label 307 of the received packet 303′ to identify a new label (e.g., new next hop label 309) and destination for the packet using the forwarding table of the router. For example, at operation 1406, when node 1420-Y may receive a packet with next hop label “9” (e.g., as described above from node 1420-Z), node 1420-Y may use the forwarding table portion of data structure 1490-Y to identify the path (e.g., row of the forwarding table) that includes a local label with a value equal to the value of the next hop label “9” of the received packet (e.g., to identify row 1450 of the forwarding table portion of data structure 1490-Y as including a local label “9” that matches the value of next hop label “9” of the received packet), and then node 1420-Y may replace the next hop label of the received packet with the next hop label of the identified path (e.g., replace next hop label “9” of the received packet with next hop label “1” of the identified row 1450 (e.g., at operation 308 by replacing label 307 with label 309)), and then node 1420-Y may forward the packet with the replaced next hop label to the next hop of the identified path (e.g., forward the received packet, but now with next hop label “1” rather than next hop label “9”, to next hop node 1420-W of the identified row 1450 (e.g., by forwarding packet 303′″ with the replaced next hop label 309 to the next hop)).

Continuing with this example, node 1420-W may receive such a packet 303′″ (e.g., packet 303′ with next hop label “1”) as incoming data and may identify, at node 1420-W, the path of the computed set of paths at the particular hop node that includes a local label with a value equal to the value of the next hop label of the received packet and (2) determine that the particular hop node is the destination node of the identified path (e.g., that node 1420-W is the egress hop of the identified path of the received packet) and (3) pop the next hop label from the received packet at the egress hop and forward the packet from the egress hop to next hop (or destination host) on directly connected LAN (e.g., at operation 1310). For example, as shown in FIG. 3, a packet with a next hop label, identified as packet 303′ (a packet with next hop label 307), may be received at a router node 320 and operation 304 may determine that the received packet 303′ may include an assigned path (e.g., the received data includes a hop label (e.g., label 307)) and then will provide that received packet 303′ to destination independent forwarding 308, which may use the label 307 of the received packet 303′ to identify that router node 320 is the egress hop for the received packet using the forwarding table of the router and then pop out the label (e.g., pop out label 307 at operation 317 or operation 321) and provide as a packet 303″″ with no next hop label to a next hop (or destination host) on directly connected LAN (e.g., dependent upon determinations at operation 310 and/or operation 319). For example, at operation 1410, when node 1420-W may receive a packet with next hop label “1” (e.g., as described above from node 1420-Y), node 1420-W may use the forwarding table portion of data structure 1490-W to identify the path (e.g., row of the forwarding table) that includes a local label with a value equal to the value of the next hop label “1” of the received packet (e.g., to identify row 1440 of the forwarding table portion of data structure 1490-W as including a local label “1” that matches the value of next hop label “1” of the received packet), and then node 1420-W may determine that there is no next hop label identified by the forwarding table portion of data structure 1490-W for the identified path, such that node 1420-W may determine that it is the egress router for the packet's flow and then pop (e.g., remove) the next hop label “1” from the received packet and then handle the packet accordingly (e.g., forward the packet from the egress hop to a next hop (or destination host) on directly connected LAN (e.g., at operation 1310)).

Therefore, FIGS. 3, 13, and 14 may illustrate an example of forwarding using label swap forwarding state, whereby traffic can be forwarded over multiple paths from the same source, and to the same destination through the use of forwarding state that may not be based on destination address information (e.g., due to a forwarding table (e.g., as used at each iteration of operation 1308 for a particular flow with respect to each packet and each hop node) may not include data specific to a destination node of the flow but may only include data indicative of a local label, a next hop label, and a next hop node). A benefit may be that this may support multiple paths (e.g., as destination based forwarding is, often, single path). Another benefit may be that this may be faster or lower power (e.g., fixed length label lookups may be easier than variable length IP address lookups). In some embodiments, forwarding state may be computed while carrying out routing computations (e.g., with source routing), while, in other embodiments, forwarding state may not be computed while carrying out routing computations (e.g., with segment routing). This may or may not be carried out by routing computation. Source routing, MPLS, and segment routing can be done either during or after. A forwarding state may be considered the data described with respect to a particular row of a communication table or a forwarding table (e.g., data for a particular path), such as labels or forwarding identifiers (e.g., forwarding identifiers may be referred to herein as labels and vice versa).

The term “autonomic” has sometimes been defined as “occurring involuntarily; automatic.” In a limited sense, an Internet routing architecture may be characterized as autonomic in that it may control network routing in response to internal stimuli. Specifically, routing may be automatically recomputed and traffic may be re-routed as network topology and link costs change.

As mentioned, a new routing model provided by this disclosure may be based on the best set of paths between any given source and destination in a network. In this new model, routes may be pre-computed (e.g., computed in response to changes in network state) that may provide the full range of performance and that may support the full range of policies available in a network. A notable innovation in this model may be the use of Boolean constraints to define policies to be enforced that may be related to the assignment of traffic to network paths. These constraints may be defined by Boolean expressions that may be composed of Boolean variables that may reflect policy-relevant network state(s).

Routing decisions may be made based on internal network state, such as link costs or the assignment of network links to administrative groups (e.g., to implement policies vs performance goals). The new routing model of this disclosure may additionally or alternatively tie Boolean variables to state that is external to the network. Examples may include, but are not limited to, time of day, threat levels (e.g., military DEFCON levels), network user state (e.g., such as the troops in combat (“TIC”) status used in the military), and/or the like. Inclusion of external state in the routing computation may allow network operators to pre-configure network configuration changes based on the value of these new Boolean constraints, thereby causing the network to respond autonomically to changes in network state.

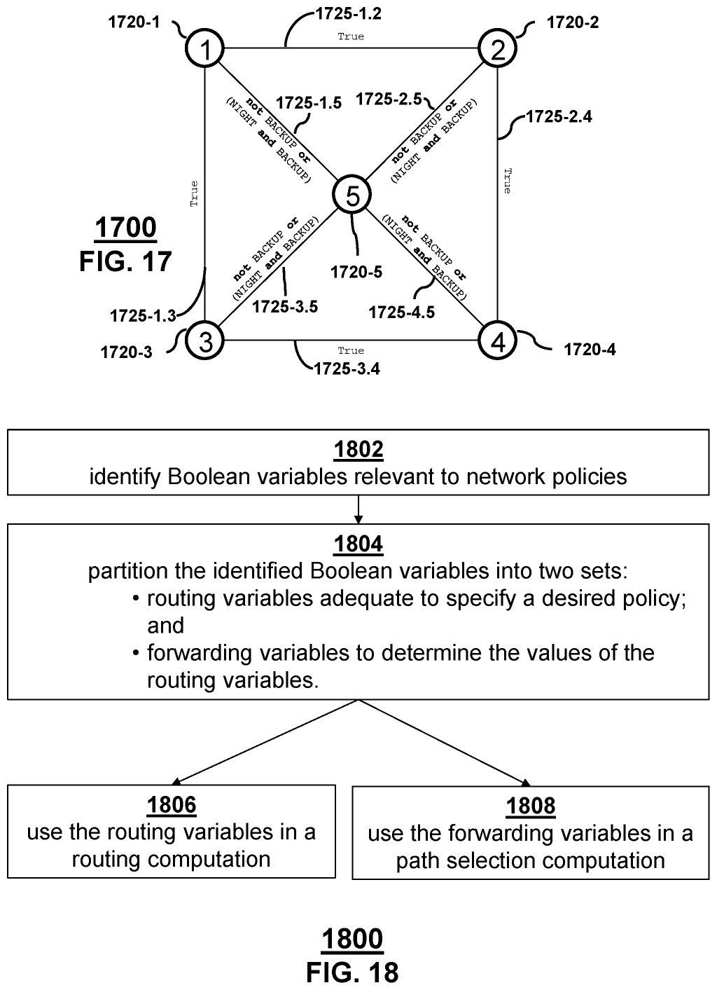

As an example, a policy may exist of not allowing backup of computer storage across an organization's core networks during the day (e.g., due to the load it would put on daytime production traffic). By defining two Boolean variables, DAYTIME and BACKUP, the DAYTIME variable may be set by the routing infrastructure based on the time of day (e.g., this variable may be True from 8 am-8 pm and False from 8 pm-8 am), and the BACKUP variable may be defined to True for backup traffic between systems and the backup server. Given these variables, the following constraint may be defined for the core network links: (1) “(not DAYTIME) or (DAYTIME and not BACKUP)”; or the similar (2) “(not BACKUP) or (NIGHT and BACKUP)” (e.g., as described with respect to FIG. 17 (e.g., with variables NIGHT and BACKUP (e.g., where the NIGHT variable may be True from 8 pm-8 am) for certain core links of a network). This policy may allow any traffic to use the core links between 8 pm and 8 am, but may not allow backup traffic over those links during the day.

This powerful and novel capability has many potential applications. The new routing model of this disclosure may be extended to (explicitly) include Boolean variables whose true/false values may reflect any policy-relevant state, where examples may include, but are not limited to, threat levels (e.g., DEFCON), time-of-day related state (e.g., night vs day, any partitioning of the day (e.g., to be used in scheduling traffic), daylight savings time, specific time zones, etc.), geographical location, jurisdictions (e.g., European Union vs. United States vs. other legal jurisdictions that might have relevance to the handling of network resources, etc.), network access control-related state, user identity, group membership, host configuration (e.g., operating system version, application software inventory and versions, patch levels for the operating system and applications, etc.), meta information about the network (e.g., router/switch fanout, path redundancy between specific locations, etc.), threat feeds (e.g., Spamhaus, the BZAR feed of Mitre Attack events, etc.), weather feeds, jurisdictions, facilities characteristics, global or current events (e.g., Super Bowl Sunday, Thanksgiving, Inauguration Day, whether or not a specific country has been designated a national threat by a government agency, etc.), and/or the like.

The autonomic nature of this may come from the fact that the true/false value of many of these Boolean variables can be determined without human intervention. Variables related to time, geographic location, and/or the like can be determined from a system clock and GPS, respectively. Network access control information can be obtained from network access control systems (e.g., open source osquery or Cisco's commercial identity services engine (“ISE”)), and threat feed sources as mentioned above, while network meta information (e.g., as described above) may be uniquely available from the routing/switching infrastructure of a network.

With a configuration based on the value of Boolean variables such as these or others, changes in variable value can be handled by the routing/switching systems itself without any human involvement or, in other words in an “involuntary or unconscious” (e.g., autonomic) manner.

This capability may have profound implications for the ability of networks to be able to respond in real-time to attacks or other environmental changes; something simply not possible with current network technology.

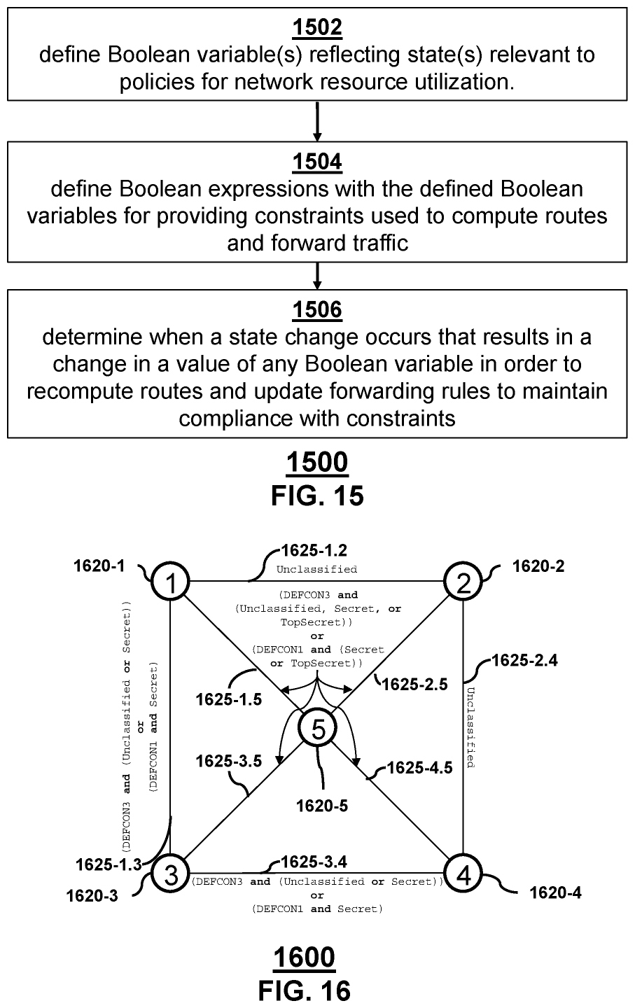

FIG. 15 is a flowchart of an illustrative process 1500 for autonomic network routing. At operation 1502, one or more Boolean variables (e.g., a set of Boolean variables) may be defined or otherwise identified that may reflect one or more states relevant to any suitable policies that may be required or available for resource utilization for a network. These variables may reflect the true/false values of any suitable any policy-relevant state including, but not limited to, threat levels (e.g., military DEFCON levels), time of day, geographic location, political or legal jurisdictions, authenticated user information (e.g., group membership information), host configuration information (e.g., operating system and application software versions and patch levels, etc.), threat feeds (e.g., Spamhaus or the BZAR feed of Mitre Attack events), “meta” information about the network (e.g., router/switch fanout, path redundancy between specific locations, etc.), and/or the like. At operation 1504, these variables may be used to define Boolean expressions that may be used to define constraints (e.g., policy constraints) for use in routing and/or forwarding of a network routing model (e.g., to implement any desired resource utilization policies through determining whether or not an expression is associated with a link and satisfied with respect to a flow to be communicated (e.g., the Boolean constraints described above (e.g., with respect to FIGS. 5-14))). At operation 1506, state changes in the values of these variables may be monitored and detected (e.g., change in time period, geographic location, threat levels, availability of new vulnerabilities, whether or not a specific country has been designated a national threat by a government agency, etc.), such as through detection of any new data (e.g., through any suitable push/pull technique for data 99 from any suitable remote data device(s) 118) and, on a detected change, recompute routing and forwarding functions (e.g., update forwarding rules), such as by re-running process 1200 or 1300, to maintain compliance with any constraints (e.g., desired policies).

The operations shown in process 1500 of FIG. 15 are only illustrative and that existing operations may be modified or omitted, additional operations may be added, and the order of certain operations may be altered.

FIG. 16 shows at least a portion of a network 1600 that may include any suitable number of nodes or router devices 1620, such as node 1620-1, node 1620-2, node 1620-3, node 1620-4, and node 1620-5. Different nodes may be communicatively coupled to one another (e.g., using communication components of the nodes) over different communication links 1625, which may differ in any suitable manner, such as by security strength, whereby links 1625 may include strongly secured link 1625-1.5 between nodes 1620-1 and 1620-5, strongly secured link 1625-2.5 between nodes 1620-2 and 1620-5, strongly secured link 1625-3.5 between nodes 1620-3 and 1620-5, strongly secured link 1625-4.5 between nodes 1620-4 and 1620-5, medium secured link 1625-1.3 between nodes 1620-1 and 1620-3, medium secured link 1625-3.4 between nodes 1620-3 and 1620-4, unsecured link 1625-1.2 between nodes 1620-1 and 1620-2, and unsecured link 1625-2.4 between nodes 1620-2 and 1620-4. One, some, or each link or one, some, or each type of link (e.g., strongly secured, medium secured, unsecured, etc.) may be associated with one or more constraints (e.g., performance constraints and/or policy constraints and/or service chaining constraints, etc.). For example, as shown, each link may be provided with at least one Boolean constraint (e.g., as a policy constraint, etc.) that may be defined by any suitable Boolean expression that may be composed of any suitable Boolean variable(s) (e.g., traffic level Boolean variables “Unclassified”, “Secret”, and “TopSecret”, and threat level variables “DEFCON3” and “DEFCON1”, although any additional or alternative Boolean variable(s) and/or Boolean constraints may be associated with one, some, or each link), which may be used to express a constraint of flows using the network. As just some specific examples, each one of strongly secured links 1625-1.5, 1625-2.5, 1625-3.5, and 1625-4.5 may include a Boolean constraint with a Boolean expression [(DEFCON3 and (Unclassified or Secret or TopSecret)) or (DEFCON1 and (Secret or TopSecret))], each one of medium secured links 1625-1.3 and 1625-3.4 may include a Boolean constraint with a Boolean expression [(DEFCON3 and (Unclassified or Secret)) or (DEFCON1 and Secret)], while each one of unsecured links 1625-1.2 and 1625-2.4 may include a Boolean constraint with a Boolean expression [Unclassified] (e.g., the expression may be satisfied as long as the traffic level Boolean variable “Unclassified” is True). Therefore, because different links of different security strength may be labeled with Boolean constraints reflecting military-style MLS, augmented with DEFCON variables, certain policies may be implemented, such as, (1) at DEFCON3 (e.g., a low threat level), traditional MLS may be implemented where strongly secured links may allow all traffic levels (Unclassified, Secret, TopSecret), where medium secured links may allow Unclassified and TopSecret traffic, and where unsecured links may allow only Unclassified traffic, and (2) at DEFCON1 (e.g., a higher threat level), Unsecured traffic may be dropped from the secured (e.g., high and medium) links (e.g., to conserve resources for handling the threat, and to protect sensitive traffic). With this configuration, changes in the DEFCON status can be communicated to the network (e.g., via a web site (e.g., as data 99 from any suitable data device 118)), and network resource management may be changed to enforce the new constraints (e.g., at operation 1506 of process 1500).

FIG. 17 shows at least a portion of a network 1700 that may include any suitable number of nodes or router devices 1720, such as node 1720-1, node 1720-2, node 1720-3, node 1720-4, and node 1720-5. Different nodes may be communicatively coupled to one another (e.g., using communication components of the nodes) over different communication links 1725, which may differ in any suitable manner, such as by core or non-core links (e.g., whether or not the link is with a core network (e.g., as may be represented by node 1720-5)), whereby links 1725 may include core link 1725-1.5 between nodes 1720-1 and 1720-5, core link 1725-2.5 between nodes 1720-2 and 1720-5, core link 1725-3.5 between nodes 1720-3 and 1720-5, core link 1725-4.5 between nodes 1720-4 and 1720-5, non-core link 1725-1.3 between nodes 1720-1 and 1720-3, non-core link 1725-3.4 between nodes 1720-3 and 1720-4, non-core link 1725-1.2 between nodes 1720-1 and 1720-2, and non-core link 1725-2.4 between nodes 1720-2 and 1720-4. One, some, or each link or one, some, or each type of link (e.g., core, non-core, etc.) may be associated with one or more constraints (e.g., performance constraints and/or policy constraints and/or service chaining constraints, etc.). For example, as shown, each link may be provided with at least one Boolean constraint (e.g., as a policy constraint, etc.) that may be defined by any suitable Boolean expression that may be composed of any suitable Boolean variable(s) (e.g., “BACKUP” and “NIGHT”, although any additional or alternative Boolean variable(s) and/or Boolean constraints may be associated with one, some, or each link), which may be used to express a constraint of flows using the network. The value of the BACKUP variable may be determined to be True or False based on whether or not the flow is backup traffic between systems and a backup server, while the value of the NIGHT variable may be determined to be True or False based on whether or not the time of day is currently between 8 pm and 8 am, although the variable values may be defined to be determined in any other suitable ways. As just some specific examples, each one of core links 1725-1.5, 1725-2.5, 1725-3.5, and 1725-4.5 may include a Boolean constraint with a Boolean expression [notBACKUP or (NIGHT and BACKUP)], which may indicate that non-backup traffic can use these links any time but backup traffic can only use them at night, while each one of non-core links 1725-1.2, 1725-1.3, 1725-2.4, and 1725-3.4 may include a Boolean constraint with a do not care or blank or True Boolean expression [True] (e.g., the expression may be satisfied no matter the value of the NIGHT variable and no matter the value of the BACKUP variable (e.g., expression [notBACKUP or BACKUP or notNIGHT or NIGHT])), which may satisfy all traffic constraints. Therefore, in this scenario, non-backup traffic can use the core links at any time but backup traffic can only the core links at night, while all traffic can use the non-core links at any time. An interesting aspect of this scenario may be that one, some, or each router/switch device of the network may be configured to detect policy change on its own by noticing time changes from day to night or vice versa. In some embodiments, the specific times for this change (e.g., 8 pm, 8 am, etc.) may be configured by a network administration.

Boolean constraints may be configured for more efficient processing for multipath routing and an expanded definition of what can be covered by the Boolean constraints may be enabled by this disclosure.

In Boolean-constrained multipath routing (“BCMR”), policies for use of network resources may be specified using Boolean constraints. These Boolean constraints may be used to determine the allowability of a requested communication relative to the policies defined by the constraints (e.g., the communication constraints). Towards this end, the communication constraints may be used in computations that may be utilized to find a path for a given communication request, and may include, but are not limited to, a routing computation that may find (1) a set of paths between a given source and destination that may be allowable relative to a set of constraints applicable to that path (e.g., operations 1202, 1302, etc.) and (2) a specific set of constraints that may apply to each such path (e.g., for a particular flow), a forwarding computation that may select a path to use for a given communication request (e.g., for a particular flow) (e.g., operations 1206, 1306, etc.). In some embodiments, there may be multiple paths for a given request that may satisfy the communication constraints, so this computation may include selecting one among potentially multiple constraint-satisfying paths.

Propositions (e.g., primitive propositions) of these Boolean constraints may be defined in terms of “any globally significant attributes of the ingress router's state that can be expressed as a true/false statement”. An example of such variables may be those “describing attributes of the traffic being forwarded.” For example, a value of 6 in a protocol field of an IP header may be represented as the Boolean variable “IPProto(TCP)”, the value 53 in a destination port field of a UDP header may be represented as the Boolean variable “UDPDestPort(DOMAIN)”, and/or the like. These kind of variables can be used to specify routing constraints.

An SDN implementation of BCMR for a routing model of this disclosure may include a significantly enhanced model of constraints to address performance problems with a “global” constraint model. This enhanced constraint model for BCMR, and the enhanced model for specifying and processing these constraints, may be new and may provide many benefits (e.g., efficiency and effectiveness).

In an enhanced constraint model, propositions (e.g., primitive propositions) may be defined to include any policy-relevant state, and may belong to one of two classes, such as bound and inferred.

Bound variables may include, but are not limited to, threat levels (e.g., DEFCON1 through DEFCON5 and/or the like, where such primitives may describe the level of attack the network is under, where such variables may reflect a state that may be set by a network administration function (e.g., manually or automated), and can be used to automatically reconfigure network policies in response to threats or attacks (e.g., dedicate more resources to countermeasure traffic and less to low priority or potentially attack traffic), time of day (e.g., ToD6 pm-8 am, ToD8 am-6 pm, and/or the like, where such primitives may be computed by the routing and forwarding functions, as needed, and can be used to define time-of-day related policies (e.g., allowing backup traffic to use network core topology at night, but not during the day, etc.)), network access control information (e.g., NAC-User-JohnDoe, NAC-Loc-HQ, NAC-Dev-Tablet-iOS-9.1, and/or the like, where such primitives may be determined by network access control systems (e.g., Cisco's Identity Services Engine), and can be used to determine attributes such as user, location, and device status for use in policy decisions), traffic attributes (e.g., content classification (e.g., for HIPPA, PHI, or MilitaryOrders), location information (e.g., LOC-EngineeringBldg, LOC-China, LOC-Dorm, LOC-CombatHQ, etc.), application information (e.g., APP-Financial System, APP-StudentSystem, APP-BattleCommand, APP-SEIM, etc.), and user state information (e.g., STATUS-TiC reflecting the “Troops in Contact” state that may be used in military operations, and STATUS-InClass for traffic from a student currently in class), and/or the like.

Inferred variables may be those whose value may be determined by the bound variables through the evaluation of a full set of communication constraints. Inferred variables may include, but are not limited to, GenomeResearch (e.g., which may be defined as true for all traffic for a given application run by authorized users of that application (and false otherwise)), TopSecret (e.g., which may be defined as true for all traffic for a command and control application between the battlefield and headquarters), BOTNet, and/or the like.

In an enhanced model that may be configured for specifying and processing communication constraints, the constraints, specified as Boolean expressions of these primitive propositions, may be divided into two classes: global vs. link, and routing vs. forwarding. Global constraints may be evaluated as a part of either the routing or forwarding computations. Link constraints may be evaluated in the routing computation whenever a path may be extended by a link (and so may be inherently routing constraints). Routing constraints may be evaluated as part of the routing computation. In general, routing constraints may be expressed in terms of a small subset of the primitive propositions (e.g., to minimize the cost of the routing computation), and may not involve bound variables (e.g., variables whose true/false value has been set), though these may be more like guidelines than actual rules. The downside of using bound variables in the routing constraints may be the need to recompute paths when truth values change (and the costly reconfiguration of forwarding state in the network), and/or using only unbound variables for routing may leave the burden of responding to truth assignment changes to the forwarding computation (e.g., thereby minimizing the need for costly forwarding state reconfiguration). Forwarding constraints may be evaluated as part of the forwarding computation, and may include all bound variables.

The following may be various examples of constraints: (1) “GenomeResearch⇔GenomeFaculty and APP-GeneSeq and LOC-HPC and LOC-GenomeDB”, which may be expressing a policy described above (e.g., true for all traffic for a genome sequencing app run by authorized users of that application, and false otherwise); (2) “TopSecret⇔APP-BattleCommand and LOC-CombatHQ and LOC-BattleField”, which may be expressing a policy described above (e.g., true for all traffic for a command and control application between the battlefield and headquarters, and false otherwise); (3) “BOTNet⇔APP-BOT-C&C and LOC-BOT-Controller”, which may be expressing a policy described above (e.g., true for all BOT C&C traffic to/from a known BOT C&C server, and false otherwise); and (4) an application of the routing constraint guidelines described above may have these three expressions used as forwarding constraints, and may limit reference to these constraints as routing link constraints of GenomeResearch, TopSecret, and BOTNet in the form of either the positive (e.g., “GenomeResearch”) or negative (e.g., “not GenomeResearch”) forms.

Therefore, an enhanced constraint model for BCMR, and an enhanced model for specifying and processing these constraints, may provide enhancements over previous models, by, for example (1) expanding the definition of primitive propositions to represent any policy-relevant state (e.g., this may go far beyond a definition of “any globally significant attribute of the ingress router's state that can be expressed as a true/false statement,” and may allow for any information that can be communicated to the routing infrastructure (e.g., SDN controller or distributed routing computation, etc.) to be used in defining policies), (2) expanding the model for specifying and processing communication constraints to include partitioning the constraint evaluation into forwarding and routing components (e.g., this may dramatically improve the efficiency of constraint processing (e.g., evaluating constraints, and updating forwarding state, etc.) over other global constraint models), and/or the like.

Boolean constraints may be distinguished into routing and forwarding constraints. Partitioning the variables in this manner may allow for optimization of the routing and forwarding processes (e.g., of processes 1200 and/or 1300). For example, in some embodiments, a routing function may compute paths and install non-traffic-specific forwarding state in the router/switches. On receipt of a new flow in the network, the state required for the flow may be determined (e.g., involving an ingress path assignment flow table entry). This allocation of functions may allow the cost of the routing function to be reduced (e.g., in terms of the number of variables used and/or the frequency of route computations), and/or may leave the forwarding function to involve the computation of only one flow table entry. The routing process may involve computing paths that enforce policies, and/or may download precomputed forwarding state to the routers/switches. Including Boolean variables reflecting, for example, traffic attributes, may require this recomputation and download process per traffic flow.

FIG. 18 is a flowchart of an illustrative process 1800 for processing Boolean constraints for use in multipath routing. At operation 1802, Boolean variables relevant to network policies may be identified (e.g., a set of Boolean variables may be identified that reflect state relevant to policies that may be required for resource utilization for a network). At operation 1804, the identified Boolean variables may be partitioned into two sets: routing variables that may be adequate to specify a desired policy and forwarding variables that may be needed to determine the values of the routing variables (e.g., the routing set of variables may be adequate to specify a desired policy in a routing computation while controlling the cost of the routing computation (e.g., limit the number of variables, select variables with lower change rates, etc.), where the routing set of variables may be relatively small in number to control the cost of the computation and/or relatively static to control the rate of routing computations, while the forwarding set of variables (e.g., the remaining variables) may be used in a forwarding process). At operation 1806, the routing variables (e.g., routing constraints 315) may be used in a routing computation (e.g., of process 1200, process 1300, etc.), while, at operation 1808, the forwarding variables (e.g., flow constraints 316) may be used in a path selection computation of the same process (e.g., of process 1200, process 1300, etc.). In some embodiments, the routing function may compute paths and/or install non-traffic-specific forwarding state in the router/switches. On receipt of a new flow in the network, the state required for the flow (e.g., involving an ingress path assignment flow table entry) may be determined. This allocation of functions may allow the cost of the routing function to be minimized (e.g., in terms of the number of variables used and/or the frequency of route computations), and/or may leave the forwarding function to involve the computation of only one flow table entry.

One implementation of the policies described in this scenario may involve the DEFCON and MLS Boolean variables of network 1600 of FIG. 16, and some set of additional variables to be used to determine the DEFCON variable values (e.g., DEFCON1, DEFCON3, etc.) and/or the MLS variable values (e.g., Unclassified, Secret, TopSecret, etc.). These additional variables may involve network address and/or port (e.g., physical and/or protocol ports) information for use in identifying MLS unclassified, secret, and top secret traffic. These values may also be determined from network access control information describing user/group information and/or workstation identification. Using the address/port solution, MLS classifications could be identified based on the source and destination hosts for specific traffic flows. For example, Boolean variables of the form IPv4xSRCAxUNCLASSIFIED, IPv4xSRCAxSECRET, IPv4xSRCAxTOPSECRET may be used to identify traffic with a source host that may be classified at the appropriate MLS sensitivity level. A similar set of variables may be set for destination addresses (e.g., replacing “SRCA” with “DSTA”). Definitions may be provided specifying what host addresses map to the different levels, and then Boolean constraints could be defined to equate a specific Boolean variable to each MLS level (e.g., the constraint: “UNCLASSIFIED iff (IPv4xSRCAxUNCLASSIFIED or IPv4xDSTAxUNCLASSIFIED)” may define the UNCLASSIFIED variable to be equivalent to the statement that traffic is being transmitted to/from a host classified at that level). With this setup, the routing variables may be defined to be DEFCON1, DEFCON3, UNCLASSIFIED, SECRET, TOPSECRET, where values of the latter three variables may be determined as described above, and the DEFCON variables may be directly set via a web interface to the system (e.g., via any suitable data 99 from any suitable data device(s) 118)). This may leave the address variables to be classified as forwarding variables, including IPv4xSRCAxUNCLASSIFIED, IPv4xDSTAxUNCLASSIFIED, IPv4xSRCAxSECRET, IPv4xDSTAxSECRET, IPv4xSRCAxTOPSECRET, and IPv4xDSTAxTOPSECRET. It is to be understood that the set of forwarding variables may include some or all of the routing variables beyond whatever variable(s) may be unique to the forwarding variable set, as the split may be for limiting the amount of variables defining the routing variable set for limiting what the routing computation may have to process.

The operations shown in process 1800 of FIG. 18 are only illustrative and that existing operations may be modified or omitted, additional operations may be added, and the order of certain operations may be altered.

One, some, or all of the processes described with respect to FIGS. 1-18 may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 13 of a network device 120). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from a central network controller device to a router device or from a data device to any network device. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

Any, each, or at least one module or component or subsystem of the disclosure may be provided as a software construct, firmware construct, one or more hardware components, or a combination thereof. For example, any, each, or at least one module or component or subsystem of system 1 may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. The number, configuration, functionality, and interconnection of the modules and components and subsystems of system 1 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

While there have been described systems, methods, and computer-readable media for providing multipath routing in data communication networks, many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the concepts of the disclosure can be practiced by other than the described embodiments, which are presented for purposes of illustration rather than of limitation.

1. A method for communicating data in a data network comprising a plurality of router nodes, the method comprising:
computing, for each router node of the plurality of router nodes, a best set of routes subject to a partial ordering;
assigning, at each router node of the plurality of router nodes, a local label that is unique to the particular router node for each computed route of the computed best set of routes for the particular router node; and
defining, at a first router node of the plurality of router nodes, a next hop label for a first computed route of the computed best set of routes for the first router node based on the local label assigned for the first computed route at a second router node of the plurality of router nodes that is the next hop router node from the first router node for the first computed route.

2. The method of claim 1, further comprising:
receiving, at the first router node, at least one initial packet of a flow;
determining flow constraints of the flow based on the received at least one initial packet;
selecting the first computed route from the computed best set of routes for the first router node based on at least a portion of the determined flow constraints; and
forwarding, from the first router node to the second router node, a packet of the flow along with the defined next hop label for the selected first computed route for the first router node.

3. The method of claim 2, wherein the determining comprises accessing a value of a Boolean constraint variable from a data device that is distinct from the plurality of router nodes.

4. The method of claim 2, wherein:
the partial ordering is for a full range of routing constraints of the data network; and
the at least one flow constraint of the flow constraints is not one of the routing constraints.

5. The method of claim 1, further comprising defining, at the second router node of the plurality of router nodes, a next hop label for the first computed route of the computed best set of routes for the second router node based on the local label assigned for the first computed route at a third router node of the plurality of router nodes that is the next hop router node from the second router node for the first computed route.

6. The method of claim 5, further comprising:
receiving, at the second router node, a packet of a flow along with a forwarded label;
identifying, at the second router node, an assigned local label for the second router node that is equal to the received forwarded label;
identifying, at the second router node, the defined next hop label for the second router node is associated with same computed route as the identified local label for the second router node; and
forwarding, from the second router node to a third router node, the received packet along with the identified defined next hop label for the second router node.

7. The method of claim 1, wherein the partial ordering is for a full range of routing constraints of the data network.

8-12. (canceled)

13. A method for communicating data in a data network comprising a plurality of router nodes, the method comprising:
computing, for each router node of the plurality of router nodes, a best set of routes subject to a partial ordering;
assigning, at each router node of the plurality of router nodes, a local label that is unique to the particular router node for each computed route of the computed best set of routes for the particular router node; and
defining, at each router node of the plurality of router nodes, a next hop label for each computed route of the computed best set of routes for the particular router node based on the local label assigned for the particular computed route at the router node that is the next hop router node from the particular router node for the particular computed route.

14. The method of claim 13, further comprising:
receiving, at a first router node, at least one initial packet of a flow;
determining flow constraints of the flow based on the received at least one initial packet;
selecting a first computed route from the computed best set of routes for the first router node based on at least a portion of the determined flow constraints; and
forwarding, from the first router node to a second router node, a packet of the flow along with the defined next hop label for the selected first computed route for the first router node.

15. The method of claim 14, further comprising:
receiving, at the second router node from the first router node, communication data comprising the forwarded packet of the flow along with the defined next hop label for the selected first computed route for the first router node;
identifying, at the second router node, an assigned local label for the second router node that is equal to the defined next hop label of the received communication data;
identifying, at the second router node, the defined next hop label for the second router node that is associated with same computed route as the identified local label for the second router node; and
forwarding, from the second router node to a third router node, the forwarded packet of the received communication data along with the identified defined next hop label for the second router node.

16. The method of claim 13, wherein the partial ordering is for a full range of routing constraints of the data network.
